(19) United States
(12) Patent Application Publication
(10) Pub. No.: US 2014/0301700 A1
(43) Pub. Date: Oct. 9, 2014

(54) OPTICAL CONNECTOR, OPTICAL TRANSMISSION MODULE, AND METHOD FOR PRODUCING OPTICAL CONNECTOR

(71) Applicants: Takahiro Matsubara, Kyoto (JP); Kazumi Nakazuru, Kanagawa (JP); Kentaro Kamei, Kyoto (JP); Naoki Takahashi, Kanagawa (JP)

(72) Inventors: Takahiro Matsubara, Kyoto (JP); Kazumi Nakazuru, Kanagawa (JP); Kentaro Kamei, Kyoto (JP); Naoki Takahashi, Kanagawa (JP)

(21) Appl. No.: 14/235,554

(22) PCT Filed: Jul. 19, 2012
(86) PCT No.: PCT/JP2012/068358

§ 371 Date: Mar. 24, 2014

(30) Foreign Application Priority Data
Jul. 28, 2011 (JP) 2011-164912
Oct. 28, 2011 (JP) 2011-237845

(51) Int. Cl. G02B 6/40

(52) U.S. Cl. CPC G02B 6/40
USPC 385/54; 29/458

(57) ABSTRACT

The optical connector has the plug for holding the plurality of optical fibers arranged in parallel in a left-right direction, and the receptacle and the board for holding the plurality of optical waveguides arranged in parallel in a left-right direction. The plug has the lower surface located along a direction the plurality of optical fibers arranged. The receptacle has, at the part which projects toward a side of the first holding member, the bottom surface which faces the lower surface and positions the lower surface, when butting joint the plurality of optical fibers and the plurality of optical waveguides. Further, a space which is located between the lower surface and the bottom surface is located below the plurality of optical fibers.

### TECHNICAL FIELD

The present invention relates to an optical connector for connecting transmission lines of light to each other, an optical transmission module, and a method for producing an optical connector.

### BACKGROUND ART

There is known an optical connector for connecting optical transmission lines configured by optical fibers etc. to each other. For example, an optical connector of Patent Literature 1 has a first holding member for holding a first optical transmission line and a second holding member for holding a second optical transmission line. The end face of the first optical transmission line is exposed from the end face of the first holding member, while the end face of the second optical transmission line is exposed from the end face of the second holding member. The first holding member and the second holding member are connected by making the end faces of the holding members abut against each other. Further, the first optical transmission line and second optical transmission line are positioned in a direction perpendicular to the optical transmission lines by guide pins which project from the first holding member being inserted into the second holding member in the abutting direction.

Various inconveniences occur in the technique of Patent Literature 1. For example, parts for inserting guide pins become necessary for both of the first and second holding members. Further, for example, noise, water, or dust is liable to enter the gap between the end faces of the holding members.

Accordingly, it is demanded to provide an optical connector which is capable of preferably connecting optical transmission lines, an optical transmission module, and a method of producing an optical connector.

### CITATIONS LIST

### Patent Literature

Patent Literature 1: Japanese Patent Publication No. 7-84147A

### SUMMARY OF INVENTION

### Solution to Problem

An optical connector according to a first aspect of the present invention has a first holding member which holds a plurality of first optical transmission lines arranged in parallel in a left-right direction and has a lower surface located along a direction the plurality of first optical transmission lines arranged; and a second holding member which holds a plurality of second optical transmission lines arranged in parallel in a left-right direction and has, at a part which projects out toward a side of the first holding member, a bottom surface which faces the lower surface and positions the lower surface, when butting joint end faces of the plurality of first optical transmission lines and end faces of the plurality of second optical transmission lines, respectively. A space which is located between the lower surface and the bottom surface is located below the plurality of first optical transmission lines.

An optical transmission module according to a second aspect of the present invention has the above-explained optical connector, the second optical transmission lines, and at least one of light emitting elements for inputting light to the second optical transmission lines and light receiving elements for receiving light output from the second optical transmission lines.

A method of production of an optical connector according to a third aspect of the present invention is a method of production of an optical connector including a holding member which holds a plurality of optical transmission lines in a state where they are arranged in parallel in a left-right direction. The method has a step of inserting the plurality of optical transmission lines arranged in parallel in the left-right direction and a binder between a first component member which becomes a lower side component member and a second component member which becomes an upper side component member which configure the holding member; and a step of curing the binder by heating the first component member and the second component member while pressing against them in an insertion direction of the plurality of optical transmission lines. A concave portion is formed in the surface of the first component member on the side opposite to the second component member, and a jig for heating and pressing is abutted against the concave portion in the step of hardening.

According to the above configurations or procedure, the optical transmission lines can be suitably connected.

### BRIEF DESCRIPTION OF DRAWINGS

FIG. 1 is a perspective view which shows an optical connector according to a first embodiment of the present invention in a disconnected state.

FIG. 2 is a perspective view which shows the optical connector in FIG. 1 in a connected state.

FIG. 3 is a perspective view which shows a board and a support member of the optical connector in FIG. 1.

FIG. 4A is a perspective view which shows a board of the optical connector in FIG. 1, FIG. 4B is a perspective view which shows a support member of the optical connector in FIG. 1, and FIG. 4C is a plan view which shows a positioning part of the board and support member.

FIG. 5 is a cross-sectional view taken along a line V-V in FIG. 2.

FIG. 6A is a cross-sectional view taken along a line VIa-VIa in FIG. 2, and FIG. 6B is an enlarged view of a region VIb in FIG. 6A.

FIG. 7 is a cross-sectional view for explaining a method of production of a plug of the optical connector in FIG. 1.

FIG. 8 is a cross-sectional view which shows a principal part of an optical connector according to a second embodiment.

FIG. 9 is a cross-sectional view which shows a principal part of an optical connector according to a third embodiment.

FIG. 10 is a cross-sectional view which shows a principal part of an optical connector according to a fourth embodiment.

FIG. 11 is a cross-sectional view which shows a principal part of an optical connector according to a fifth embodiment.

FIG. 12 is a cross-sectional view which shows a principal part of an optical connector according to a sixth embodiment.

FIG. 13A is a cross-sectional view which shows a principal part of an optical connector according to a seventh embodiment, and FIG. 13B is an enlarged view of a region XIIIb in FIG. 13A.

FIG. 14A is a cross-sectional view which shows a principal part of an optical connector according to an eighth embodiment, and FIG. 14B is an enlarged view of a region XIVb in FIG. 14A.

FIG. 15 is a perspective view which shows an optical connector according to a ninth embodiment of the present invention in a disconnected state.

FIG. 16 is a perspective view which shows a lid member of the optical connector in FIG. 15.

FIG. 17 is a cross-sectional view which shows the optical connector in FIG. 15.

FIG. 18A to FIG. 18C are cross-sectional views for explaining the mode of operation of the optical connector in FIG. 15.

FIG. 19 is a cross-sectional view which shows an optical connector according to a 10th embodiment.

FIG. 20 is a cross-sectional view which shows an optical connector according to an 11th embodiment.

FIG. 21 is a cross-sectional view which shows an optical connector according to a 12th embodiment.

FIG. 22 is a cross-sectional view which shows an optical connector according to a 13th embodiment.

FIG. 23 is a cross-sectional view which shows an optical connector according to a 14th embodiment.

FIG. 24A is an enlarged view of a region XXIVa in FIG. 23, and FIG. 24B and FIG. 24C are enlarged cross-sectional views showing principal parts of optical connectors according to first and second modifications of the 14th embodiment.

FIG. 25A is a perspective view which shows an optical connector according to a 15th embodiment, FIG. 25B is a cross-sectional view taken along a line XXVb-XXVb in FIG. 25A, and FIG. 25C is a cross-sectional view taken along a line XXVc-XXVc in FIG. 25A.

FIG. 26 is a perspective view which shows a lid member of the optical connector according to a 16th embodiment.

### DESCRIPTION OF EMBODIMENTS

Below, optical connectors according to embodiments of the present invention will be explained with reference to the drawings. Note that, in the second and following embodiments, regarding configurations the same as or similar to the configurations of the already explained embodiments, notations the same as those of the configurations of already explained embodiments will be attached, and the explanation will be sometimes omitted.

### First Embodiment

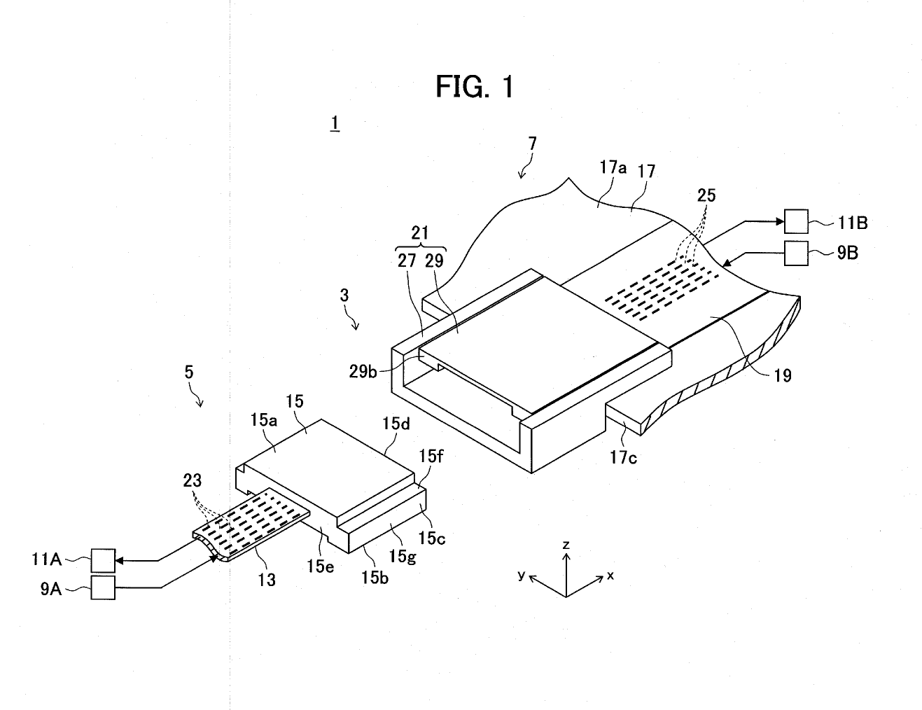

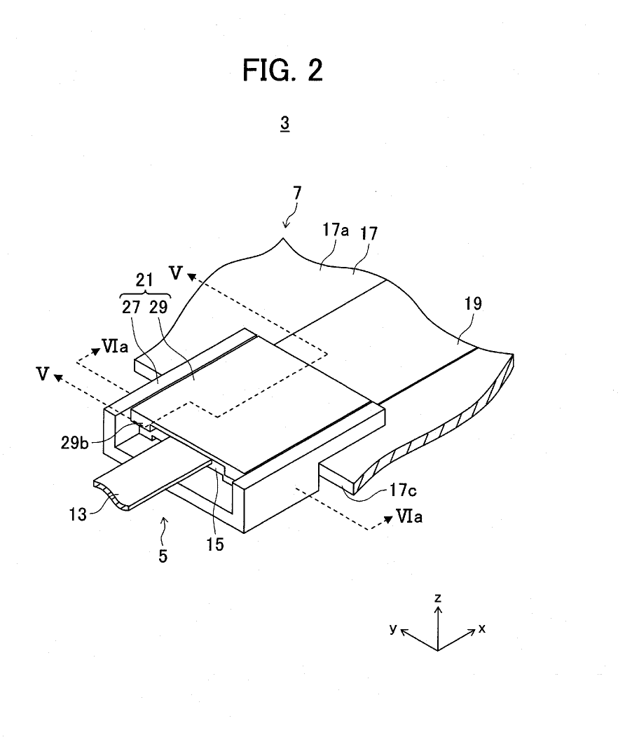

FIG. 1 is a perspective view which shows an optical connector 3 according to a first embodiment of the present invention and an optical transmission module 1 including the optical connector 3 in a disconnected state. Further, FIG. 2 is a perspective view which shows the optical connector 3 in a connected state.

Note that, in the optical connector 3, any direction may be used as upward or downward. However, in the following explanation, for convenience, an orthogonal coordinate system xyz is defined, and use is made of a term of “upper surface” or “lower surface” where the positive side in the z-direction is the upper part.

The optical transmission module 1 has a plug assembly 5 and a receptacle assembly 7 which is connected to the plug assembly 5.

Further, the optical transmission module 1, as shown in FIG. 1, has a light emitting element 9A and light receiving element 11A which are connected to the plug assembly 5 and a light emitting element 9B and light receiving element 11B which are connected to the receptacle assembly 7.

The light generated in the light emitting element 9A is received by the light receiving element 11B through the plug assembly 5 and receptacle assembly 7 in a connected state. Further, the light generated in the light emitting element 9B is received by the light receiving element 11A through the receptacle assembly 7 and plug assembly 5 in a connected state. Note that, the light emitting element 9B and light receiving element 11B may be mounted on a board 17 or may be provided separately from the board 17.

The plug assembly 5 has an optical cable 13 which is connected on one end side to the light emitting element 9A and light receiving element 11A and a plug 15 which is provided on the other end side of the optical cable 13.

The receptacle assembly 7 has the board 17, an optical waveguide strip 19 which is connected on one end side to the light emitting element 9B and light receiving element 11B, and a receptacle 21 which is provided on the other end side of the optical waveguide strip 19.

By insertion of the plug 15 into the receptacle 21, the optical cable 13 and the optical waveguide strip 19 are connected. Note that, the optical connector 3 is configured including the plug 15, a portion of the board 17, and the receptacle 21.

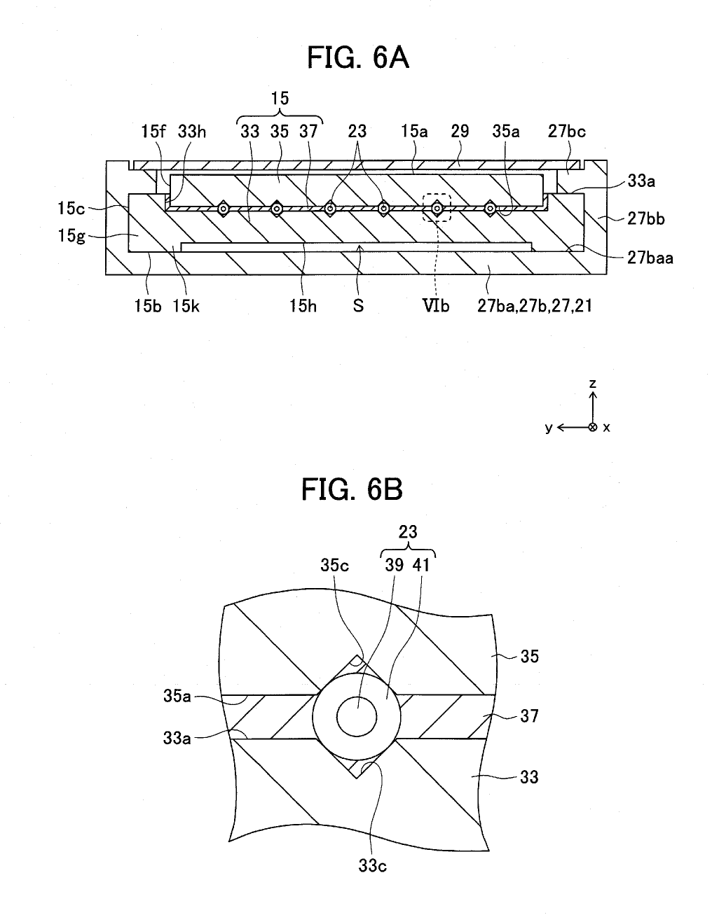

The optical cable 13, as shown in a see-through manner in FIG. 1, has a plurality of optical fibers 23. Each optical fiber 23 has a core 39 (see FIG. 6B) and cladding 41 (see FIG. 6B) and has a coating film according to need. The diameter of the optical fibers 23 may be suitably set. However, for example the diameter is 70 μm to 200 μm. Note that, the plurality of optical fibers 23 may be covered by sheaths and be bundled at the outside of the plug 15 or may not be bundled. However, a case where they are bundled is exemplified in the present embodiment.

The plurality of optical fibers 23 are for example arranged in a line in the diametrical direction in at least the inside of the plug 15 (see FIG. 6A). Specifically, in the present embodiment, as shown in FIG. 6A, the optical fibers 23 are arranged in a line in a y-direction. The plurality of optical fibers 23 are arranged so that adjacent optical fibers 23 are spaced apart from each other by a certain interval.

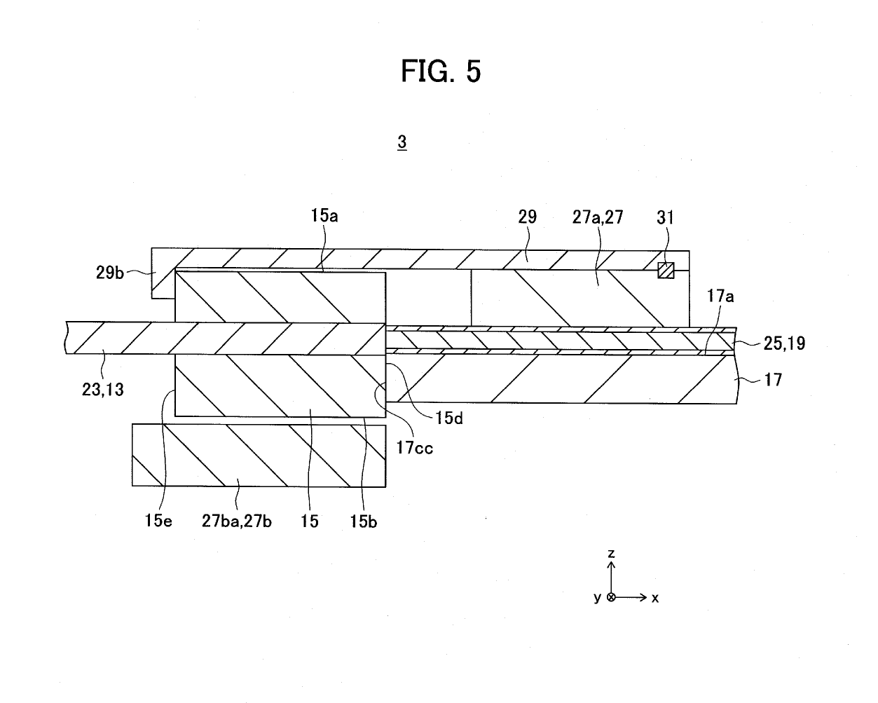

The plug 15 is for example formed in a roughly box shape and has an upper surface 15a, a lower surface 15b, two side surfaces 15c, a front surface (first connection part 15d), and a rear surface 15e. The dimensions of the plug 15 may be suitably set. However, for example, one side when viewed on a plane is about a few millimeters. The optical cable 13 is inserted into the plug 15 in a direction from the rear surface 15e to the first connection part 15d. The end faces of the plurality of optical fibers 23 are exposed in the first connection part 15d (see FIG. 5).

The end faces of the plurality of optical fibers 23 (end faces of the cores 39) may be arranged so as to form the same plane in the first connection part 15d of the plug 15, or may be arranged inside the plug 15 on the inner side from the first connection part 15d of the plug 15, or may be arranged so as to project from the first connection part 15d of the plug 15.

When the end faces of the optical fibers 23 (end faces of the cores 39) are arranged inside the plug 15 on the inner side from the first connection part 15d of the plug 15, at the time of connection with the optical waveguides 25, the end faces of the optical fibers 23 (end faces of the cores 39) can be made harder to scratch. On the other hand, when the end faces of the optical fibers 23 (end faces of the cores 39) are arranged so as to project from the first connection part 15d of the plug 15, optical connection with the optical waveguides 25 can be made easier.

The board 17 is configured by for example a rigid type printed circuit board. The board 17 is for example formed in a flat plate shape and has a first major surface 17a, a second major surface (notation is omitted) of a back surface of the same, and an outer circumferential surface (notation is omitted) facing the outer circumferential side of these major surfaces. A portion of the outer circumferential surface becomes a facing surface 17c which faces the plug 15 side. For example, when viewing the board 17 on a plane, the facing surface 17c is formed in a linear state over the range of arrangement of the receptacle 21 (the facing surface 17c is formed in a flat plane shape).

The optical waveguide strip 19 is provided on the first major surface 17a of the board 17 and has a plurality of optical waveguides 25 as shown in a see-through manner in FIG. 1.

Each optical waveguide 25 has the same configuration as that of the optical fiber as is well known and has a not shown core and cladding. Note that, the optical waveguide 25 may be made a slab type, embedded type, half-embedded type, or other suitable method. The end face of the optical waveguide 25 is exposed on the facing surface 17c (see FIG. 5). A plurality of optical waveguides 25 are arranged in a line in a direction locating along the facing surface 17c (y-direction) on at least the end face side which is exposed from the facing surface 17c.

The receptacle 21 has a support member 27 which is attached to the board 17 and supports the plug 15 and a lid member 29 which is attached to the support member 27 and covers the plug 15. The support member 27 and lid member 29 may be formed by a resin, ceramic, or metal or other suitable material.

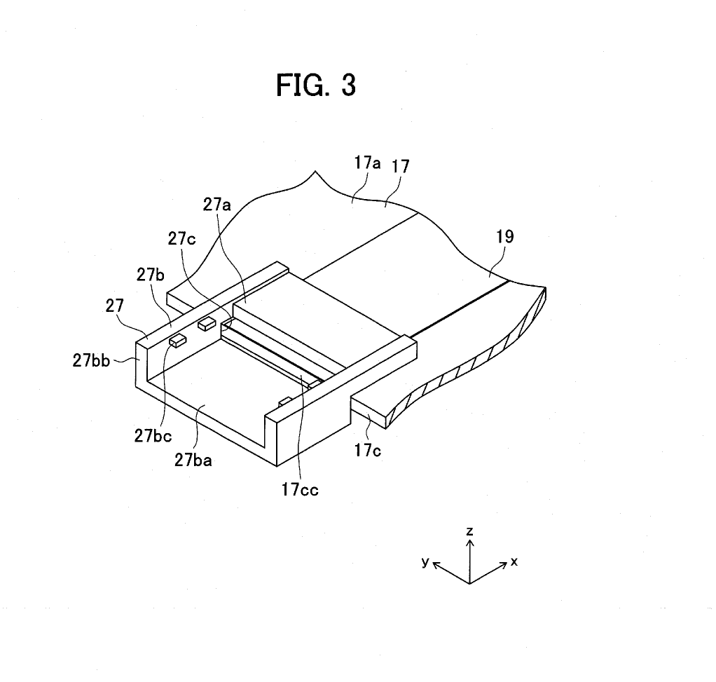

FIG. 3 is a perspective view which shows the receptacle assembly 7 in a state where the lid member 29 is detached.

The support member 27 for example has an attachment portion 27a which mainly contributes to the attachment of the support member 27 to the board 17 and a holding portion 27b which mainly contributes to holding of the plug 15.

The attachment portion 27a is for example formed in roughly a plate shape and is laid over the first major surface 17a of the board 17 (optical waveguide strip 19). The attachment portion 27a and the board 17 are fastened by for example fixing members such as screws or solder, or a binder including an inorganic material or organic material or other suitable means.

The holding portion 27b is for example formed in a shape configuring a groove portion having roughly a rectangular cross-section and has a bottom surface portion 27ba and two side surface portions 27bb. The concave portion configured by the bottom surface portion 27ba and side surface portions 27bb is given a shape and size by which plug 15 roughly fits therewith. The bottom surface portion 27ba can be suitably designed matching with the shape of the lower surface 15b of the plug 15. In the present embodiment, a case where the bottom surface portion 27ba is formed to exhibit a flat surface will be explained.

In the side surface portions 27bb, guide projection portions 27bc which project to the inside side of the holding portion 27b may be provided. In the present embodiment, the case where the guide projection portions 27bc are provided will be explained. For example, two guide projection portions 27bc are provided in one side surface portion 27bb along the insertion direction of the plug 15.

On the other hand, as shown in FIG. 1, in the plug 15, the corner portions formed by the upper surface 15a and the side surfaces 15c are cut away whereby guide grooves 15f which extend in the insertion direction into the receptacle 21 are formed. From another viewpoint, on the side surfaces of the plug 15, gripped portions 15g which project sideward and extend in the insertion direction into the receptacle 21 are formed. The positions of the guide grooves 15f correspond to the positions of the guide projection portions 27bc.

Further, the plug 15 is inserted into the receptacle 21 so as to insert the gripped portions 15g into the spaces between the bottom surface portion 27ba and the guide projection portions 27bc and is guided and positioned by the bottom surface portion 27ba, side surface portions 27bb, and guide projection portions 27bc. Specifically, the plug 15 is positioned in the z-direction by fitting the gripped portions 15g between the bottom surface portion 27ba and the guide projection portions 27bc and is positioned in the y-direction by fitting it between the two side surfaces 27bb. Note that, the positioning in the y-direction can be carried out by the guide projection portions 27bc in place of or addition to the side surface portions 27bb.

The dimension of the holding portion 27b in the y-direction may be designed for example by the relationship between the core diameters in the y-direction of the optical waveguides 25 and the core diameters in the y-direction of the optical fibers 23. That is, the optical waveguides 25 and the optical fibers 23 would be displaced due to a gap in the y-direction which is formed due to a dimensional difference of the holding portion 27b and the plug 15, therefore the dimension in the y-direction of the holding portion 27b may be determined by considering how much leakage of light is permissible between the optical waveguides 25 and the optical fibers 23.

Returning to FIG. 3, an opening 27c for exposing a portion of the facing surface 17c of the board 17 (second connection part 17cc) is formed between the attachment portion 27a and the holding portion 27b. In the second connection part 17cc, end faces of the plurality of optical waveguides 25 are exposed (see FIG. 5).

When the plug 15 is inserted into the receptacle 21, the first connection part 15d of the plug 15 abuts against the second connection part 17cc. Due to this, the end faces of the plurality of optical fibers 23 exposed in the first connection part 15d and the end faces of the plurality of optical waveguides 25 exposed in the second connection part 17cc face each other, therefore the plurality of optical fibers 23 and the plurality of optical waveguides 25 are optically connected (see FIG. 5).

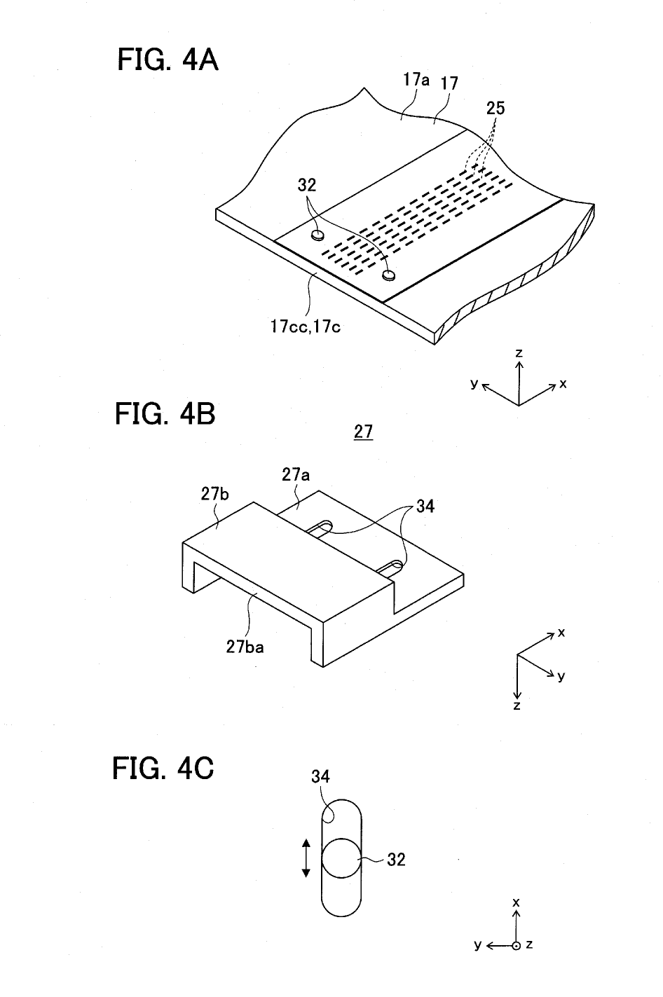

FIG. 4A is a perspective view shown by detaching the support member 27 from the configuration in FIG. 3. FIG. 4B is a perspective view of the support member 27 seen from the lower side.

As shown in FIG. 4A, on the first major surface 17a of the board 17, projection portions 32 which project from the first major surface 17a are provided. On the other hand, as shown in FIG. 4B, On the other hand, as shown in FIG. 4B, in the attachment portion 27a of the receptacle 21, holes 34 in which the projection portions 32 are inserted are formed.

The projection portions 32 are for example provided on the two sides of the plurality of optical waveguides 25. The planar shapes of the projection portions 32 may be rectangular, circular, or other suitable shapes (circular in the present embodiment). The projection portions 32 may be formed by a resin, ceramic, or metal or other suitable material. Further, the projection portions 32 may be suitably fixed to the board 17 by fixing them to the first major surface 17a by solder or a binder, burying them in the board 17, configuring them by portions of the board 17, or the like. A plurality of projection portions 32 may be formed. When a plurality of projection portions 32 are formed, they may be formed in the same shapes and same sizes or may be formed in different shapes and sizes from each other. When the plurality of projection portions 32 are formed in different shapes and sizes from each other, erroneous placement of the holes 34 with respect to the board 17 can be prevented.

The holes 34 are for example formed in long shapes which are elongated in the x-direction (the direction toward which the first connection part 15d and the second connection part 17cc abut against each other). Note that, the holes 34 may be concave portions having bottom surfaces or may be through-holes (concave portions in the present embodiment).

FIG. 4C is a plan view of a projection portion 32 and a hole 34.

The inside diameter in the y-direction of the holes 34 is the same as the outside diameter in the y-direction of the projection portions 32. Accordingly, when inserted in the holes 34, the projection portions 32 are limited in movement with respect to the holes 34 in the y-direction (the direction perpendicular to the abutting direction of the first connection part 15d and second connection part 17cc and perpendicular to the projection direction of the projection portion 32). That is, movement in the y-direction of the receptacle 21 relative to the board 17 is limited.

On the other hand, the inside diameter of the holes 34 in the x-direction (the abutting direction of the first connection part 15d and second connection part 17cc) is larger than the outside diameter in x-direction of the projection portions 32. Accordingly, during the assembly process (before the support member 27 is fixed to the board 17 by solder or the like), the projection portions 32 are moveable in the holes 34 in the x-direction. That is, the position in x-direction of the receptacle 21 relative to the board 17 can be adjusted.

FIG. 5 is a cross-sectional view taken along a line V-V in FIG. 2.

The lid member 29 is for example made of a elastically deformable material such as a resin or metal and is formed in roughly a plate shape. Further, the lid member 29 is fixed on one end side to the attachment portion 27a by the support member 31 and is formed on the other end side as a free end. The support member 31 may be configured by solder, a screw, or other suitable means. On the free end of the lid member 29, engagement parts 29b which engage with the rear surface 15e of the plug 15 in the insertion direction of the plug 15 are formed.

The plug 15 is inserted into the holding portion 27b while bending the lid member 29 upward. After the insertion, by engagement of the engagement parts 29b with the rear surface 15e and gripping of the plug by the engagement parts 29b and second connection part 17cc, positioning in the x-direction is carried out.

Note that, the distance from the second connection part 17cc to the engagement parts 29b before the insertion of the plug 15 is preferably a bit shorter than the distance from the rear surface 15e of the plug 15 to the first connection part 15d so that the plug 15 can be pressed toward the second connection part 17cc side by the engagement parts 29b after insertion of the plug 15. The lid member 29 may have a portion abutting against the upper surface 15a of the plug 15 and thereby contribute to the positioning in z-direction of the plug 15.

FIG. 6A is a cross-sectional view taken along a line VIa-VIa in FIG. 2.

The plug 15 has a first component member 33 which is supported by a bottom surface 27baa of the bottom surface portion 27ba of the receptacle 21, a second component member 35 which is supported by the first component member 33, and a binder 37 for adhering the first component member 33 and the second component member 35. The optical fibers 23 are held in the plug 15 by being gripped by the first component member 33 and second component member 35.

The first component member 33 is formed in roughly a plate shape and is for example rectangular when viewed on a plane. Further, the lower surface of the first component member 33 configures the lower surface 15b of the plug 15. In the lower surface 15b, a concave portion 15h is formed. Further, in the upper surface 33a of the first component member 33, a concave portion 33h with which the lower side part of the second component member 35 roughly fits is formed.

By formation of the concave portion 15h, a space S is formed between the lower surface 15b of the plug 15 and the bottom surface 27baa of the receptacle 21. From another viewpoint, the plug 15 abuts against the bottom surface 27baa at support projection portions 15k formed at the two sides of the concave portion 15h to be positioned on the bottom surface 27baa.

The concave portion 15h (space S) is for example formed in a thin box shape and ranges from the first connection part 15d to the rear surface 15e in the plug 15 (formed in a groove shape having constant depth (z-direction) and width (y-direction) and extending in the x-direction). Various dimensions of the concave portion 15h (support projection portions 15k) may be suitably set so that various effects which will be explained later can be suitably obtained. As an example, the width of the concave portion 15h is larger than the width of the plurality of optical fibers 23 overall, the depth of the concave portion 15h is about 0.05 mm, and the width of the support projection portion 15k is 0.5 mm to 1 mm.

The concave portion 33h is for example formed in a thin box and ranges from the first connection part 15d to the rear surface 15e in the plug 15 (formed in a groove shape having constant a depth (z-direction) and width (y-direction) and extending in the x-direction).

The second component member 35 is for example formed in a thin box shape. The width (y-direction) and length (x-direction) thereof are the same extent as those of the concave portion 33h (strictly speaking, the width of the second component member 35 is a bit smaller than the width of the concave portion 33h).

The thickness (z-direction) of the second component member 35 is set larger than the depth of the concave portion 33h. Accordingly, when the second component member 35 is arranged in the concave portion 33h, the upper side part of the second component member 35 projects upward from the first component member 33. As a result, guide grooves 15f are formed on the two sides of the second component member 35, and the lateral side parts of the first component member 33 function as the gripped portions 15g.

The first component member 33 and second component member 35 may be formed by the same material or by materials which have equal thermal expansion coefficients. By configuring the first component member 33 and second component member 35 by the same material or by materials which have equal thermal expansion coefficients in this way, thermal stress generated between the two can be mitigated. The first component member 33 and second component member 35 are for example formed by a resin, ceramic, or metal.

The binder 37 is interposed across the entire distance between the first component member 33 and the second component member 35. Note that, the binder 37 is adhered to the optical fibers 23. The binder 37 is comprised of for example a thermosetting resin. The thermosetting resin is for example an epoxy resin or phenol resin.

FIG. 6B is an enlarged view of a region VIb in FIG. 6A.

In the upper surface 33a of the first component member 33 (bottom surface of the concave portion 33h) and the lower surface 35a of the second component member 35, groove portions 33c and 35c for positioning the optical fibers 23 in the y-direction are respectively formed. The groove portions 33c and 35c are for example given triangle-shaped cross-sections and have two sides which abut against the optical fibers 23. Note that, a groove portion may also be formed only in the first component member 33 which is directly related with the positioning in the y-direction of the plug 15 with respect to the receptacle 21.

The optical fibers 23 are gripped by the first component member 33 and second component member 35. However, from another viewpoint, they function as spacers for separating the first component member 33 and the second component member 35 from each other. Further, the binder 37 is filled in the gaps.

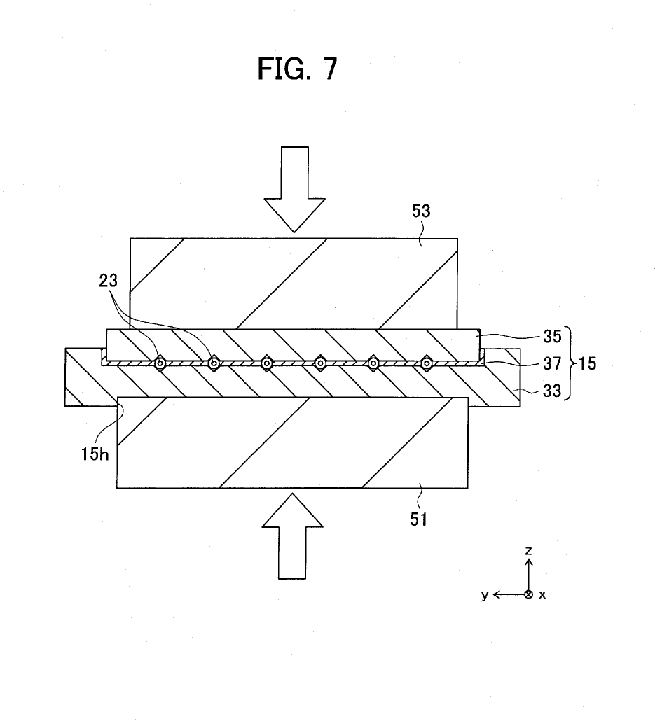

FIG. 7 is a cross-sectional view corresponding to FIG. 6A which explains the method of production of the optical connector 3, in more detail, the method of production of the plug 15.

First, a plurality of optical fibers 23 and binder 37 are gripped by the first component member 33 which becomes the lower side component member of the plug 15 and the second component member 35 which becomes the upper side component member of the plug 15. Next, by jigs 51 and 53, the first component member 33 and second component member 35 are pressed in the gripping direction while being heated to thereby cure the binder 37 made of a thermosetting resin or the like. Due to this, compared with the case of the first component member which does not have a concave portion, the first component member 33 can be made thinner by the amount of the concave portion 15h, therefore the distance between the jig 51 and the binder 37 can be made shorter and the binder 37 can be more easily cured.

At this time, the bottom surface of the concave portion 15h may be pressed and heated by fitting the jig 51 with the concave portion 15h of the first component member 33 (making it abut against the bottom surface and side surfaces of the concave portion 15h). In this case, the jig 51 gives heat to the binder 37 through the part of the first component member 33 which has become thinner, therefore the efficiency of heating is improved. Further, by fitting the jig 51 with the concave portion 15h, positional displacement in the y-direction of the first component member 33 is suppressed. By the jig 51 having a relatively large abutting area that fits with the concave portion 15h, suppression of inclination of the first component member 33 and further improvement of heating efficiency are expected. As a result, in a state where inclination of the first component member 33 and second component member 35 with respect to the optical fibers 23 is suppressed, the binder 37 can be cured.

As described above, in the present embodiment, the optical connector 3 has the plug 15 for holding the plurality of optical fibers 23 in the state where they are arranged in parallel in the left-right direction, and the receptacle 21 and the board 17 for holding the plurality of optical waveguides 25 in the state where they are arranged in parallel in the left-right direction. The plug 15 has the lower surface 15b which locates along the direction of arrangement of the plurality of optical fibers 23. The receptacle 21 has, at the part which projects to the first holding member side, the bottom surface 27baa which faces the lower surface 15b and positions the lower surface 15b when butting joint the plurality of optical fibers 23 and the plurality of optical waveguides 25. Further, between the lower surface 15b and the bottom surface 27baa, a space S which overlays the plurality of optical fibers 23 when viewing these surfaces on a plane is formed.

Accordingly, the plug 15 is supported (more preferably held) by the receptacle 21. Therefore, for example, streamlining and reduction of size of the plug 15 and protection of the end faces of the optical fibers 23 and optical waveguides 25 by the receptacle 21 are facilitated.

Further, since the space S is configured, dissipation of heat from the plug 15 can be improved even in a case where heat from the light emitting element 9A or light receiving element 11A or another element or electrical circuit etc. arranged at the periphery is transferred to the plug 15.

Further, in the plug 15, even in a case where the part between the optical fibers 23 and the lower surface 15b (the first component member 33) thermally expands/thermally contracts and the first component member 33 is deformed, the abutting of the region in the lower surface 15b against the bottom surface 27ba due to the space S, the region being superposed on the space S, can be suppressed. That is, it is possible to suppress reception of the reaction force by the lower surface 15b from the bottom surface 27baa and floating of the plug 15 when thermal expansion/thermal contraction occurs in the first component member 33. As a result, positional displacement between the optical fibers 23 and the optical waveguides 25 or deviation of the optical axis can be suppressed. In particular, when there are a plurality of optical fibers 23, the length becomes long in the direction of arrangement (Y-direction) and the flat plate shaped parts increase, therefore it is possible to make the optical connector (particularly the bottom surface of the receptacle 21) harder to be influenced by warping/torsion in addition to simple expansion/contraction.

Further, even in a case where heat of a nearby element which is transferred through the board 17 or heat due to outside disturbance is transferred to the optical connector 3, suppression of unnecessary heat buildup of the connector 3 can be made easier (heat dissipation can be made easier) by the space S, therefore occurrence of warping/torsion of the first component member 33 can be suppressed. As a result, the first component member 33 is resistant to heat, and the first component member 33 is resistant to displacement of the optical axis even if affected by heat.

Further, since the first component member 33 has a space S, the area of the lower surface 15b of the plug 15 which contacts the bottom surface 27baa of the receptacle 21 can be reduced. Therefore, sliding friction between the receptacle 21 and the plug 15 can be made smaller. As a result, even in a case where minute foreign matter (for example dust or board fiber) exists on the bottom surface 27baa of the receptacle 21, due to existence of the space S, the plug 15 will seldom ride over the foreign matter, therefore deviation of the optical axis can be suppressed.

Further, since the plug 15 has the space S with the receptacle 21 in this way, manufacturing error of the plug 15 can be absorbed. Due to this, the yield with respect to the shape such as warping or torsion at the time of shaping of the plug 15 (for example first component member 33) can be improved. Contrary to this, in a case where the plug does not have space with the receptacle, the flatness of the plug and the receptacle is bad, therefore a reduction of yield due to warping or torsion is apt to be caused.

In particular, in a case where the space S has a width including the width of the plurality of optical fibers 23 overall, the effect of suppression of displacement of the optical fibers 23 described above becomes conspicuous. Further, in the case where the lower surface 15b has the concave portion 15h configuring the space S, the first component member 33 becomes thin and consequently the thermal expansion/thermal contraction of the first component member is reduced, therefore the displacement of the optical fibers 23 is further suppressed.

### Second Embodiment

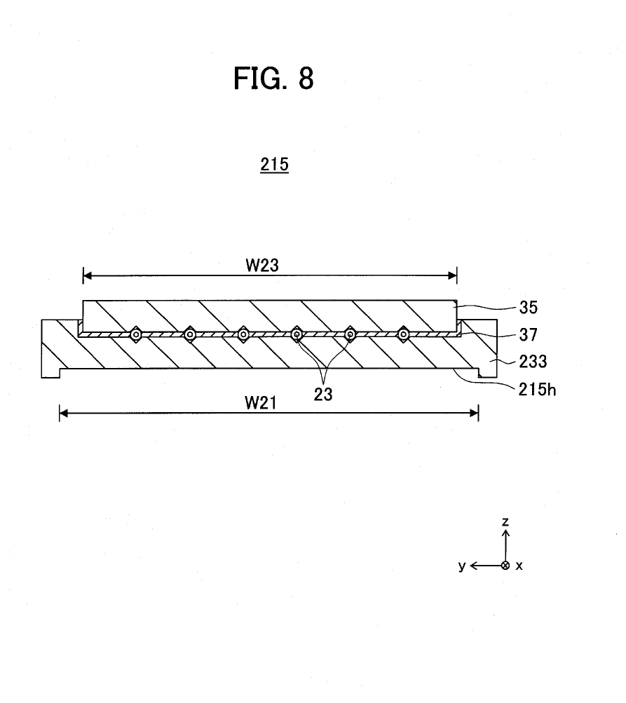

FIG. 8 is a cross-sectional view corresponding to FIG. 6A which shows a plug 215 according to a second embodiment.

In the first embodiment, the width of the concave portion 15h was larger than the width of the plurality of optical fibers 23 overall and was narrower than the width of the adhesion region of the binder 37 (width of the second component member 35). In the present embodiment, however, a width W21 of a concave portion 215h of a second component member 233 becomes broader than a width W23 of the binder 37. Note that, the rest of the configuration is the same as the configuration in the first embodiment.

The binder 37 thermally expands/thermally contracts in the same way as the first and second component members. Accordingly, by making the width W21 of the concave portion 215h broader than the concave portion 33h including configurations which change in dimensions (first component member/binder), the thermal expansion etc. of the plug 15 are more preferably absorbed/mitigated, so the positional deviation of the optical fibers 23 is suppressed.

### Third Embodiment

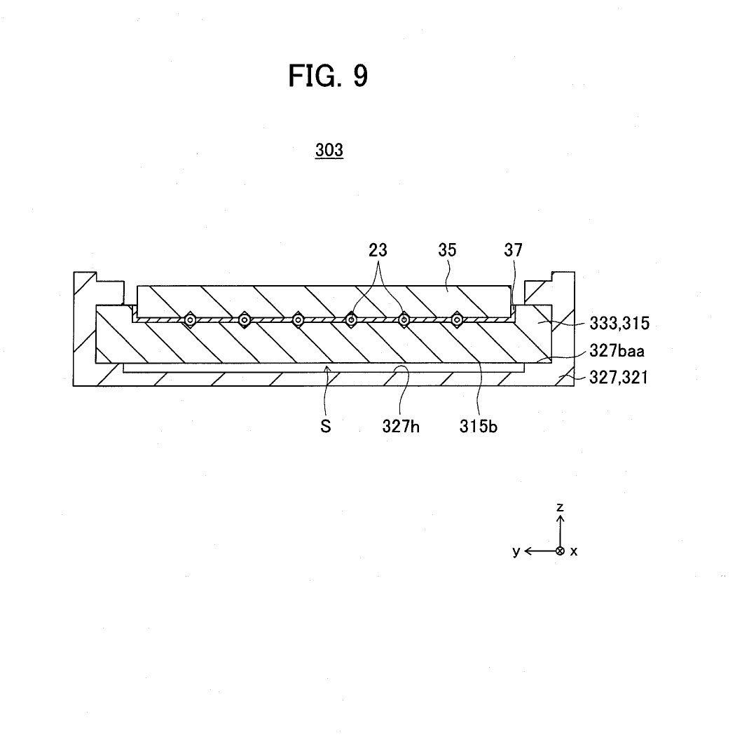

FIG. 9 is a cross-sectional view corresponding to FIG. 6A which shows an optical connector 303 according to a third embodiment.

In the optical connector 303, no concave portion is not formed in a lower surface 315b of a plug 315 (first component member 333). On the other hand, a concave portion 327h is formed in a bottom surface 327baa of a receptacle 321 (support member 327). Further, a space S is configured by the concave portion 327h.

In this way, formation of the space S on the receptacle 321 side is also possible. Further, in the same way as the first embodiment, the space S absorbs thermal expansion/thermal contraction of the plug 15 and consequently contributes to suppression of positional deviation of the optical fibers 23.

Note that, in the same way as the second embodiment, the concave portion 327h is formed broader than the adhesion region of the binder 37. Note, the concave portion 337h may have the same broadness as that in the first embodiment.

### Fourth Embodiment

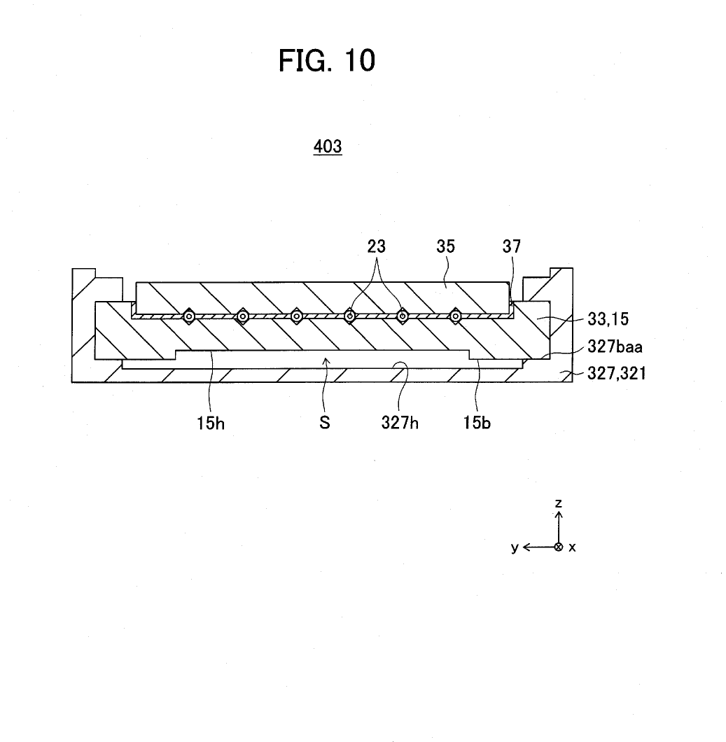

FIG. 10 is a cross-sectional view corresponding to FIG. 6A which shows an optical connector 403 according to a fourth embodiment.

The plug 15 is the same one as that in the first embodiment, and the receptacle 321 is the same one as that in the third embodiment. That is, the concave portion 15h is formed in the lower surface 15b of the plug 15, and the concave portion 327h is formed in the bottom surface 327baa of the receptacle 321. Further, the space S is configured by the two of the concave portion 15h and the concave portion 327h.

The width of the concave portion 15h becomes narrower than the width of the concave portion 327h. Accordingly, the space S changes in height in the width direction. Specifically, the space S has a broader width than the width of the adhesion region of the binder 37 overall. Further, the height becomes larger in a range which is narrower than the width of the adhesion region of the binder 37 and broader than the width of the optical fibers 23 overall.

In this way, the space S may be configured by the concave portions of the two of the plug 15 and the receptacle 321 and may change in height. Further, in a region which is positioned below the optical fibers 23, that is, a region in which thermal expansion due to the heat which is transferred by the optical fibers 23 is relatively large, by making the height of the space S relatively large, thermal expansion/thermal contraction of the plug 15 can be effectively absorbed by the space S while securing the strength of the optical connector 3.

### Fifth Embodiment

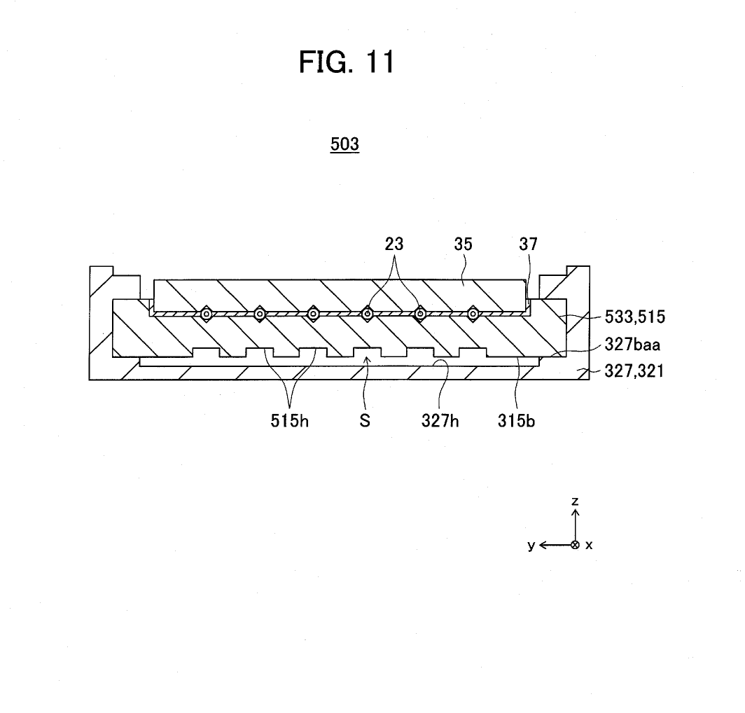

FIG. 11 is a cross-sectional view corresponding to FIG. 6A which shows an optical connector 503 according to a fifth embodiment.

The optical connector 503 has the receptacle 321 the same as those in the third and fourth embodiments and configures a space S which changes in height in the same way as the fourth embodiment. Note, the size and position of arrangement of concave portions 515h formed in a lower surface 515b of a plug 515 (first component member 533) are different from those in the fourth embodiment.

Specifically, a plurality of concave portions 515h are provided in a region which is positioned below the plurality of optical fibers 23. Note that, the concave portions 515h extend along the plurality of optical fibers 23 (in the x-direction) and are formed in a groove state. By formation of concave portions 515h in the region which is positioned under the plurality of optical fibers 23 (at positions corresponding to the optical fibers 23) in this way, the heat dissipation of the plug 515 can be improved and the mechanical strength of the first component member 533 can be maintained. Further, by changing the interval, dimensions, etc. of the concave portions 515h, it can be made possible to adjust bending/torsion etc. at the time of shaping of the first component member 533 itself. Also by such a configuration, the same effect as that by the fourth embodiment can be expected.

### Sixth Embodiment

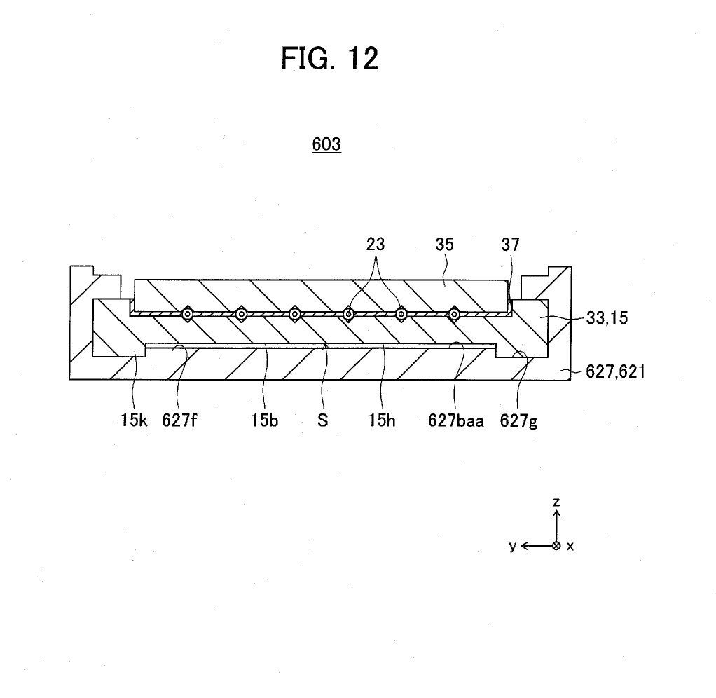

FIG. 12 is a cross-sectional view corresponding to FIG. 6A which shows an optical connector 603 according to a sixth embodiment.

The plug 15 is the same as that in the first embodiment. In a bottom surface 627baa of a receptacle 621 (support member 627), grooves 627g with which the support projection portions 15k on the two sides of the concave portion 15h of the plug 15 fit are formed. From another viewpoint, in the receptacle 621, a positioning portion 627f (projection portion) is formed abutting against the inner wall surface of the concave portion 15h. Note, the grooves 627g are narrower than the concave portion 15h, therefore the space S is formed between the lower surface 15b of the plug 15 and the bottom surface 627baa in the same way as the other embodiments.

In the present embodiment, in addition to the effect of absorption of thermal expansion/thermal contraction of the plug 15 by the space S, the concave portion 15h for forming the space S is utilized for positioning in the y-direction of the plug 15, therefore the effect that positioning of the optical fibers 23 can be carried out with a simple configuration is exhibited.

### Seventh Embodiment

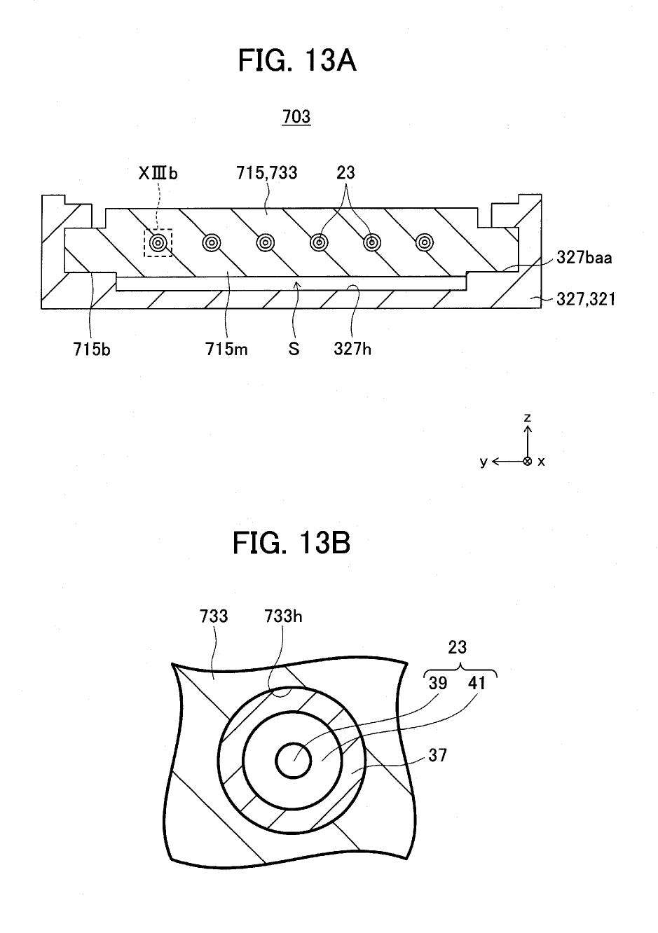

FIG. 13A is a cross-sectional view corresponding to FIG. 6A which shows an optical connector 703 according to a seventh embodiment. FIG. 13B is an enlarged view of a region XIIIb in FIG. 13A.

A plug 715 of the optical connector 703, in place of the first component member and second component member which grip the plurality of optical fibers 23, has a component member 733 comprised of the first component member and second component member seemingly integrally formed. In the component member 733, a plurality of through holes 733h (FIG. 13B) are formed. The plurality of optical fibers 23 are inserted into the plurality of through holes 733h to be held. Gaps between the optical fibers 23 and the inner circumferential surfaces of the through holes 733h are filled with the binder 37 (FIG. 13B). Note that, the material of the component member 733 may be formed by a resin, ceramic, or metal or other suitable material in the same way as the first component member and second component member.

In such a configuration, for example, the amount of the binder 37 can be made small, therefore it becomes easier to adjust the positions of the optical fibers 23. Further, for example, the amount of the binder 37 located among the optical fibers 23 is reduced, therefore the pitch of the plurality of optical fibers 23 can be made small. Further, for example, there is no longer a binder layer arranged between the first component member and the second component member, therefore reduction of thickness of the plug 715 is facilitated. The reduction of the amount of the binder 37, which is one of factors of thermal expansion/thermal contraction, and suppression of displacement by the space S combine to suppress the positional deviation of the optical fibers 23 more.

Further, the optical connector 703, in the same way as the third embodiment, has the receptacle 321 (support member 327) which has the concave portion 327h formed in the bottom surface 327baa. On the other hand, at the lower surface 715b of the plug 715, a projecting positioning portion 715m which fits with the concave portion 327h, but has a smaller projecting amount than the depth of the concave portion 327h is formed. Accordingly, the concave portion 327h is utilized not only for the formation of the space S, but also for the positioning of the plug 715.

### Eighth Embodiment

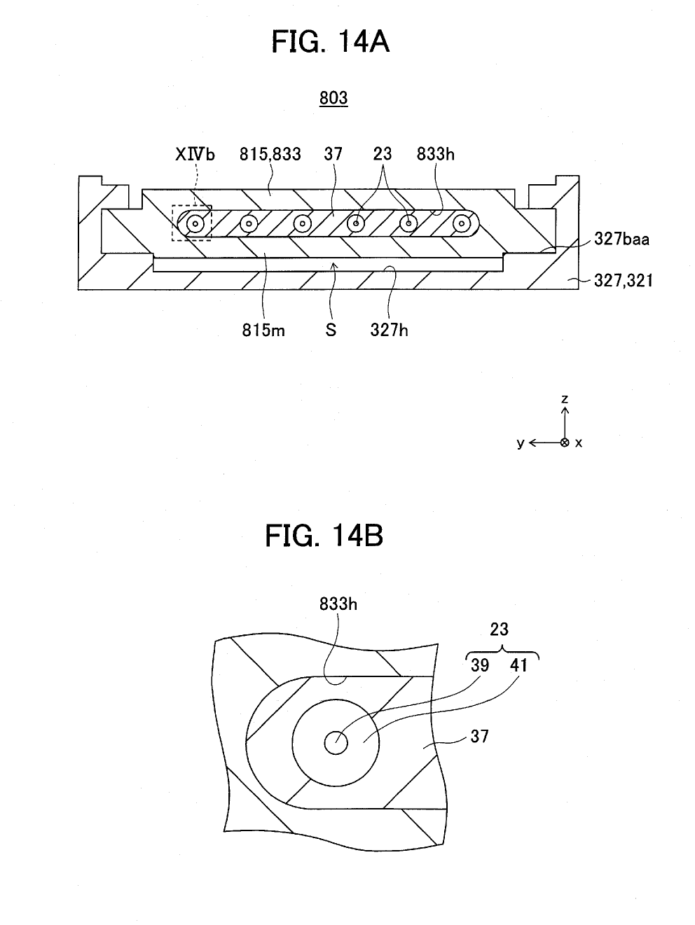

FIG. 14A is a cross-sectional view corresponding to FIG. 6A which shows an optical connector 803 according to an eighth embodiment. FIG. 14B is an enlarged view of a region XIVb in FIG. 14A.

A plug 815 of the optical connector 803, in the same way as the seventh embodiment, has a component member 833 comprised of the first component member and second component member seemingly integrally formed. Further, the component member 833, in the same way as the component member 733 in the seventh embodiment, makes the projecting positioning portion 815m fit with the concave portion 327h of the receptacle 321.

Note, in the component member 833, a through hole 833h into which the plurality of optical fibers 23 are inserted together is formed. A gap between the plurality of optical fibers 23 and the through hole 833h is filled with the binder 37 in the same way as the seventh embodiment. Note that, the space S is preferably formed over the width (y-direction) of the through hole 833h.

In the eighth embodiment as well, in the same way as the seventh embodiment, compared with the configuration of adhering the first component member and the second component member in the first embodiment etc., the amount of the binder 37 is reduced, therefore a reduction of size of the plug 815 and another various effects are exhibited.

### Ninth Embodiment

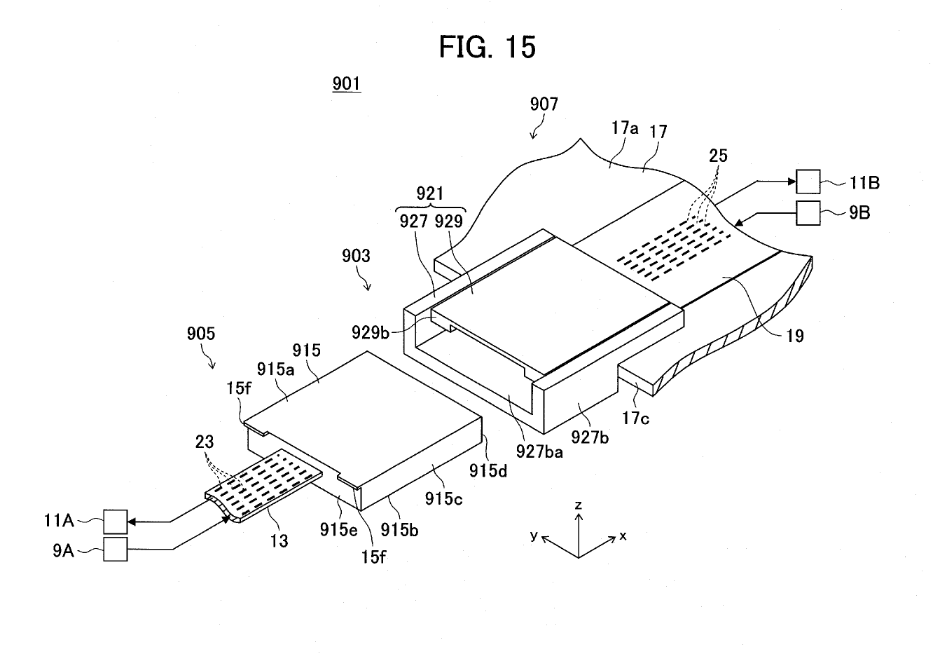

FIG. 15 is a perspective view corresponding to FIG. 1 which shows an optical connector 903 and an optical transmission module 901 including the optical connector 903 according to a ninth embodiment of the present invention in a disconnected state.

The optical connector 903, in the same way as the first embodiment, connects the optical cable 13 and the optical waveguide strip 19 by insertion of a plug 915 of a plug assembly 905 into a receptacle 921 of a receptacle assembly 907. Its schematic configuration is the same as the configuration in the first embodiment. Note, the shapes of these members concerned with the positioning of the plug 915 with respect to the receptacle 921 differ from those in the first embodiment. Specifically, this is as follows.

The plug 915, for example, in the same way as the plug 15 in the first embodiment, is formed in roughly a box shape and has an upper surface 915a, lower surface 915b, two side surfaces 915c, front surface (first connection part 915d), and rear surface 915e. Further, the plug 915 has an engaged portion 915f contributing to the positioning of the plug 915 with respect to the receptacle 921.

Note that, in the plug 915, a case where the guide grooves 15f (FIG. 1) for positioning and the concave portion 15h (FIG. 6) configuring the space S are formed will be explained. Note, in the plug 915, as shown in FIG. 15, a space S need not be formed. Further, the plug 915 may be configured by two component members as in the first embodiment or may be configured by one component member as in the seventh embodiment. By formation of the space S in the plug 915 in this way, the surface area can be made broader, therefore heat dissipation of the plug 915 can be improved.

The receptacle 921, in the same way as the first embodiment, has a support member 927 and a lid member 929. The configuration of the support member 927 is the same as the configuration of the support member 27 in the first embodiment except that the guide projection portions 27bc (FIG. 3) are not provided corresponding to the fact that the guide grooves 15f are not formed in the plug 915.

FIG. 5 is a perspective view of the lid member 929 seen from the lower part.

The lid member 929 has an extension part 929a which is supported by the support member 927, engaging function parts 929b which engage with the plug 915, and an abutting part 929c which is provided on the extension part 929a and abuts against the plug 915.

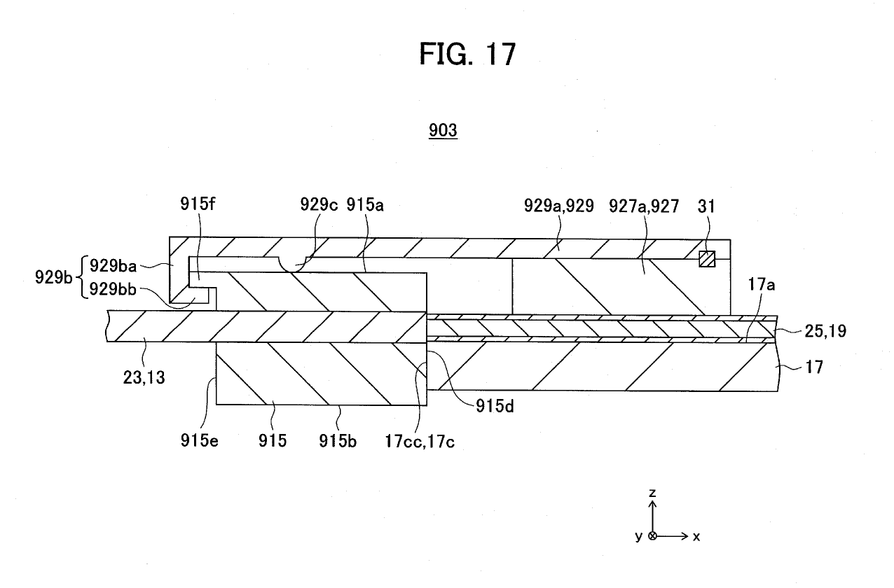

The extension part 929a is for example formed in roughly a rectangular plate shape, extends in the x-direction (the abutting direction of the first connection part 915d and second connection part 17cc (see FIG. 3)), and spreads in the y-direction (direction of arrangement the plurality of optical waveguides 25). The extension part 929a is for example fixed at the end part of the positive side in the x-direction (the second connection part 17cc side with respect to the first connection part 915d) with respect to the attachment portion 927a of the support member 927 by the support portions 31 (see FIG. 17) configured by fastening members such as screws or solder, a binder containing an inorganic material or organic material, or the like and is limited in parallel movement in the x-direction, y-direction, and z-direction and in rotation around the x-axis, around the y-axis, and around the z-axis. That is, the extension part 929a is supported on one end by a fixed support and is formed on the other end as a free end in a cantilever manner.

The engaging function parts 929b are for example provided at the end part of the extension part 929a on the negative side in the x-direction (the side closer to the first connection part 915d relative to the second connection part 17cc) and engage with engaged parts 915f which are formed on the upper surface 915a side of the rear surface 915e of the plug 915. The engaging function parts 929b and engaged parts 915f are for example provided at the positions which become the two sides of the region of arrangement of the plurality of optical fibers 23.

The abutting part 929c projects from the surface of the extension part 929a on the negative side in the z-direction (surface on the side of projection of the engaging function parts 929b) and can abut against the upper surface 915a of the plug 915 toward the negative side in the z-direction. The abutting part 929c for example extends in the direction of arrangement of the plurality of optical fibers 23 and plurality of optical waveguides 25 (y-direction). Note that, the cross-section of the abutting part 929c which is perpendicular to the y-direction may be given a suitable shape.

FIG. 17 is a cross-sectional view corresponding to FIG. 5 which shows an optical connector 903 in a connected state. Note, illustration of parts such as the holding portion 927b of the support member 927 (bottom surface portion 927ba, FIG. 15) is omitted.

The engaging function parts 929b have first engagement parts 929ba which project from the front end of the extension part 929a to downside (direction intersecting with the abutting direction of the first connection part 915d and the second connection part 17cc) and second engagement parts 929bb which project from the front ends of the first engagement parts 929ba to the positive side in the x-direction (direction from the first connection part 915b side toward the second connection part 17cc side). On the other hand, the engaged parts 915f project from the rear surface 915e of the plug 915 to the negative side in the x-direction. Further, the first engagement parts 929ba engage with the engaged parts 915f toward the positive side in the x-direction, and the second engagement parts 929bb engage upward with respect to the engaged parts 915f.

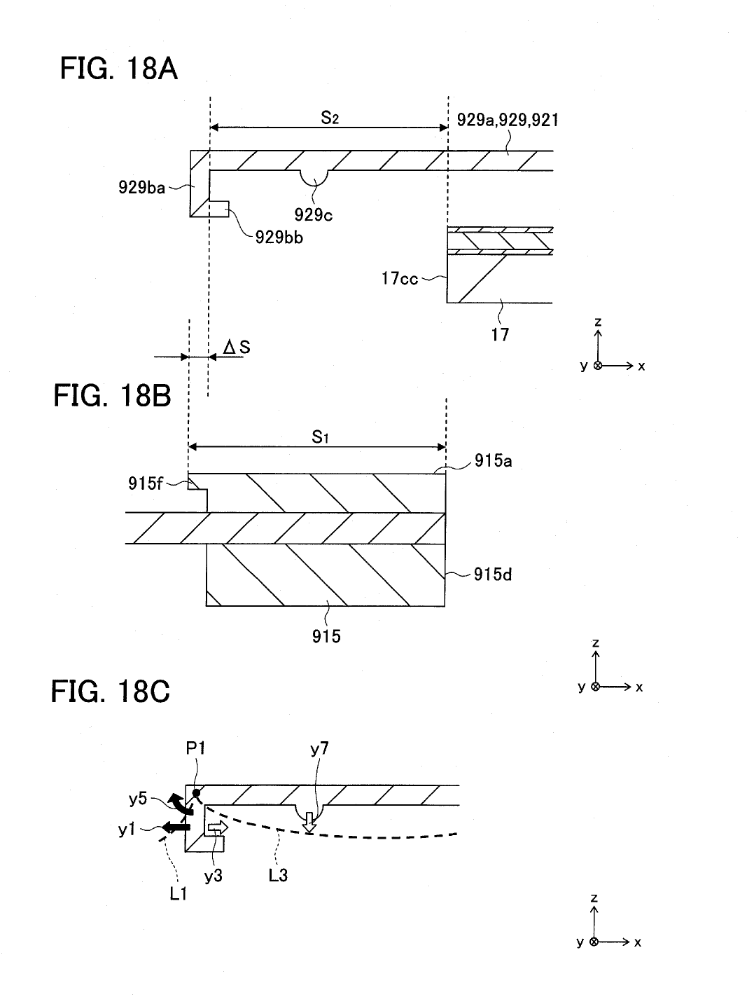

FIG. 18A and FIG. 18B are cross-sectional views for explaining the dimensions relating to the optical connector 903, and FIG. 18C is a cross-sectional view for explaining the mode of operation of the optical connector 903.

As shown in FIG. 18A, a distance from the second connection part 17cc of the board 17 to the first engagement parts 929ba of the receptacle 21 (strictly speaking, the point of action of the first engagement parts 929ba with respect to the engaged parts 915f) is defined as S₂. Further, as shown in FIG. 18B, in the plug 915, a distance from the first connection part 915d to the engaged parts 915f (strictly speaking, the point of action of the engaged parts 915f with respect to the first engagement parts 929ba) is defined as S₁. At this time, the receptacle 921 is attached to the board 17 so that S₁>S₂ is satisfied. Note that, the attachment structure of the receptacle 921 (support member 927) to the board 17 is as explained with reference to FIG. 4.

Since S₁ is made larger than S₂, when the first engagement parts 929ba are engaged with the engaged parts 915f, as shown in FIG. 18C, the first engagement parts 929ba receive force indicated by an arrow y1 from the engaged parts 915f and exhibit a state of displacement as indicated by a dotted line L1 due to elastic deformation of the lid member 929. Further, the first engagement parts 929ba impart force in the positive side of x-direction which occurs due to a restoring force of the lid member 929 to the engaged parts 915f as indicated by an arrow y3. Due to this, a state where the first connection part 915d is pressed against the second connection part 17cc is exhibited.

Further, the first engagement parts 929ba are limited in movement of their bases (points P1) to the negative side in the x-direction relative to the second connection part 17cc (board 17) by the extension part 29a, support member 27, and support 31, therefore the force indicated by the arrow y1 causes a moment around the points P1 which is indicated by an arrow y5. This moment is transmitted to the extension part 929a as the moment which deflects the extension part 929a as indicated by a dotted line L3. In other words, force which displaces the abutting part 929c to the negative side in the z-direction is caused. As a result, the abutting part 929c imparts force indicated by an arrow y7 to the upper surface 915a of the plug 915.

The plug 915 given the force indicated by the arrow y7 obtains a reaction force against the force from the second engagement parts 929bb. Further, the plug 915 can obtain a reaction force by frictional force between the first connection part 915d and the second connection part 17cc. Further, by continued pressing by the force indicated by the arrow y7, the plug 915 is suppressed in fluctuation in the z-direction relative to the board 17 after the connection. The force for pressing against the plug 915 can be set so as to become for example 4N to 20N. As the method of adjusting the force pressing against the plug 915, there is a method of adjusting for example the material of the lid member 929, the shape of the first engagement parts 929ba of the lid member 929, the shape of the engaged parts 915f of the plug 915, and the relationship of S₁ and S₂.

Note that, the extension part 929a need only be given a moment that tries to bend the extension part 929a so that the positive side in the z-direction is recessed. It is not necessary to actually bend the part compared with that before engagement (the abutting part 929c may abut against the plug 915 without bending). However, the extension part 929a may actually be bent compared with that before engagement so that the positive side in the z-direction is recessed or may have been bent before the engagement so that the negative side in the z-direction is recessed and the bending may be corrected after the engagement.

The position in the z-direction of the plug 15 is determined according to the lid member 929 and the second connection part 17cc as explained above, therefore the bottom surface portion 927ba of the holding portion 927b may abut or not abut against the lower surface 915b of the plug 15. When the bottom surface portion 927ba of the holding portion 927b and the lower surface 915b of the plug 15 abut against each other, the movement of the plug 915 in the up/down direction (z-direction) can be suppressed, therefore connection of the optical waveguides 25 and optical fibers 23 can be held well.

In the above embodiment, the optical connector 903 has the plug 915 having the first connection part 915d at which first end faces of the optical fibers 23 are exposed, the second holding member (board 17 and support member 927) having the second connection part 17cc at which first end faces of the optical waveguides 25 are exposed, and the lid member 929 which is supported by the second holding member and engages with the plug 915 when making the first connection part 915d and the second connection part 17cc abut against each other in a certain connection direction (x-direction) and connecting the optical fibers 23 and the optical waveguides 25. The lid member 929 has the extension part 929a which extends from the second connection part 17cc side to the first connection part 915d side and is supported by the second holding member so that movement in x-direction of the part on the second connection part 17cc side is suppressed, the first engagement parts 929ba which project to the direction (z-direction) perpendicular to the x-direction at the part of the extension part 929a on the first connection part 915d side and can engage with the engaged parts 915f of the plug 915 in the direction (positive side in the x-direction) from the first connection part 915d side to the second connection part 17cc side, and the abutting part 929c which is positioned further to the second connection part 17cc side from the first engagement parts 929ba of the extension part 929a and can abut against the plug 915 toward the side at which the first engagement parts 929ba project. The distance S₂ in the x-direction from the second connection part 17cc to the first engagement parts 929ba before the engagement of the first engagement parts 929ba is shorter than the distance S₁ in the x-direction from the first connection part 915d to the engaged parts 915f.

Accordingly, as explained with reference to FIG. 18C, by the abutting part 929c pressing against the plug 915 to the negative side in the z-direction, positional deviation of the plug 915 to the positive side in the z-direction can be suppressed. As a result, guide pins are unnecessary, therefore the number of members can be reduced. That is, by using the plug assembly 905 and receptacle assembly 907 which have such structures, it becomes unnecessary to provide guide pins in the plug 915, therefore the plug 915 can be reduced in size.

Further, in the present embodiment, as the plug assembly 905, use is made of a structure of the plug assembly 5 which has the space S. For this reason, the area of the first connection part 15d can be made smaller compared with the case where the plug assembly does not have a space, therefore the force for pressing the first connection part 15d against the second connection part 17cc can be made stronger. This is because even when the restoring force applied by the lid member 929 is the same, the force of pressing can be strengthened by making the contact area smaller.

Further, the pressing is maintained by the restoring force of the lid member 929, therefore it is possible to make it harder for deviation to occur due to loose engagement as in positioning by guide pins. Further, the lid member 929 for positioning in x-direction is used too for positioning in z-direction by the abutting part 929c, therefore the configuration is simplified and the connection work is facilitated. As a result, the work efficiency of insertion/extraction operations of the plug 915 is improved, and the optical waveguides 25 and the optical fibers 23 can be positioned with a high positional accuracy, therefore the optical waveguides 25 and the optical fibers 23 can be stably connected.

The lid member 929 further has the second engagement parts 929bb which is supported by the extension part 929a at the first engagement part 929ba side from the abutting part 929c and can engage with the plug 915 to the side (positive side in the z-direction) opposite to the side to which the first engagement parts 929ba project.

Accordingly, when the force indicated by the arrow y1 (FIG. 18C) creates a moment rotating the lid member 929 around the support 31, it is suppressed that the first engagement parts 929ba are disengaged. Further, the force indicated by the arrow y1 is utilized for the force for efficiently pushing the abutting part 929c down to the plug 915 side.

The second holding member has the board 17 which has the second connection part 17cc and the support member 927 which is connected to the board 17 and supports the lid member 929.

Accordingly, for example, in the case where the optical module includes the board 17 which is provided with the optical waveguides 25, by attaching the receptacle 921 to the board 17, that board 17 is utilized as a portion of the optical connector 3, whereby the optical waveguides 25 of the board 17 can be directly connected to the optical fibers 23. From another viewpoint, the receptacle 921 does not have to include the optical fibers or optical waveguides. Accordingly, a reduction of the number of members and simplification of the optical connector 903 are achieved.

One of the board 17 and the support member 927 (board 17 in the present embodiment) has the projection portions 32 (FIG. 4A) which project to the side to which the first engagement parts 929ba project or to the side opposite to the former (the opposite side in the present embodiment). The other of the board 17 and the support member 927 (support member 927 in the present embodiment) has holes 34 (see FIG. 4B) in which the projection portions 32 are inserted so that the movement is suppressed in the direction (y-direction) perpendicular to the connection direction (x-direction) and perpendicular to the projection direction of the projection portions 32.

Accordingly, the receptacle 921 can be accurately positioned in the y-direction relative to the board 17 and therefore the optical fibers 23 and the optical waveguides 25 can be suitably connected.

The inside diameter of the holes 34 in the connection direction (x-direction) is larger than the outside diameter of the projection portions 32 in the x-direction (FIG. 4C).

Accordingly, by adjusting the position of the support member 927 in the x-direction relative to the board 17, the distance S₂ between the first engagement parts 929ba of the lid member 929 which is supported by the support member 927 and the second connection part 17cc of the board 17 can be adjusted. Accordingly, for the plugs 915 having various distances S₁, the relationship S₂<S₁ is realized and the mode of operation explained with reference to FIG. 18C can be obtained. That is, the universalness of the receptacle 921 becomes high. Note that, the adjustment may be carried out at the time of production of the optical connector 903 (at the time of attachment of the receptacle 921 to the board 17) or may be carried out at any time after production by making the fastening means of the support member 927 and board 17 screws which are inserted into the long holes extending in the x-direction which are formed in either of the support member 927 or board 17 and screwing them into the other.

At the first connection part 915d, the end faces of the plurality of optical fibers 23 are aligned and exposed in the width direction (y-direction) perpendicular to the connection direction (x-direction) and perpendicular to the abutting direction (z-direction) of the abutting part 929c. At the second connection part 17cc, the end faces of the plurality of optical waveguides 25 are aligned and exposed in the y-direction. The abutting part 929c extends in the y-direction.

Accordingly, positioning in the z-direction of the plurality of optical fibers 23 and the plurality of optical waveguides 25 can be easily carried out. As a result, for example, utilization of the optical connector 903 for an optical module for large volume optical communications is promoted.

### 10th Embodiment

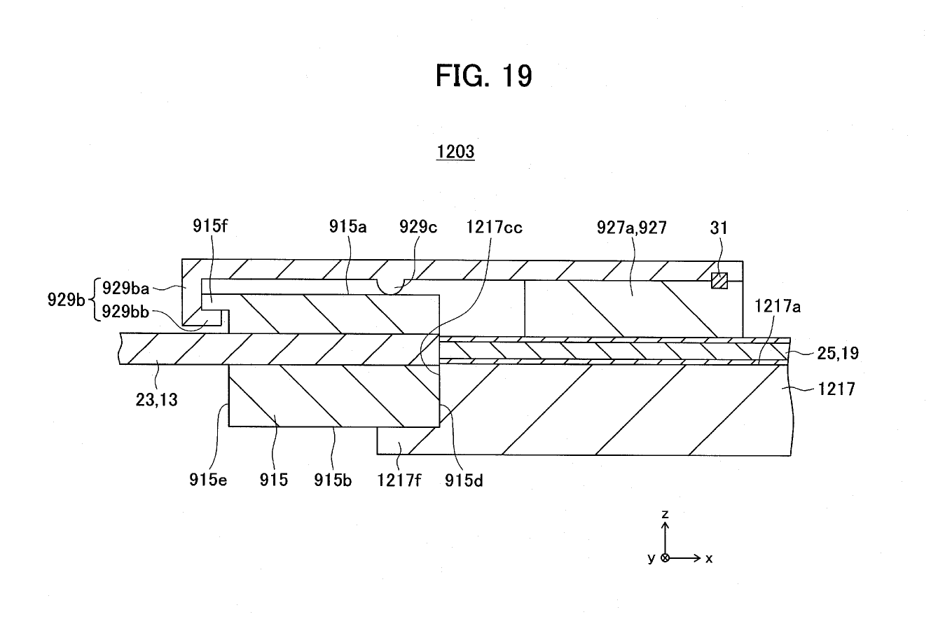

FIG. 19 is a cross-sectional view similar to FIG. 17 and shows an optical connector 1203 according to a 10th embodiment.

In the optical connector 1203, a board 1217 has a support part 1217f capable of supporting the plug 915 from the side of the plug 915 opposite to the abutting part 929c.

Accordingly, it is possible to press the plug 915 against the support part 1217f by the abutting part 929c to position the plug 915 accurately in the z-direction of the plug 915. As explained in the ninth embodiment, the plug 915 can be supported from the bottom surface side by the bottom surface portion 927ba (FIG. 15) of the holding portion 927b of the support member 927. However, by forming the support part 1217f directly on the board 1217 which is provided with the optical waveguides 25, positioning of the plug 915 (optical fibers 23) with respect to the optical waveguides 25 can be more correctly carried out. Note that, the support part 1217f may be formed by a ceramic or other material which is resistant to elastic deformation. When the support part 1217f is formed by a ceramic material, the support part 1217f may be formed integrally with the board 1217.

Note that, the support part 1217f is superposed on the abutting part 929c in a state where the first engagement parts 929ba engage with the plug 915 and when viewed by a plan view in a see-through manner in the abutting direction (z-direction) of the abutting part 929c. By formation of the support part 1217f in this way, generation of unforeseen moment with respect to the plug 915 is suppressed.

### 11th Embodiment

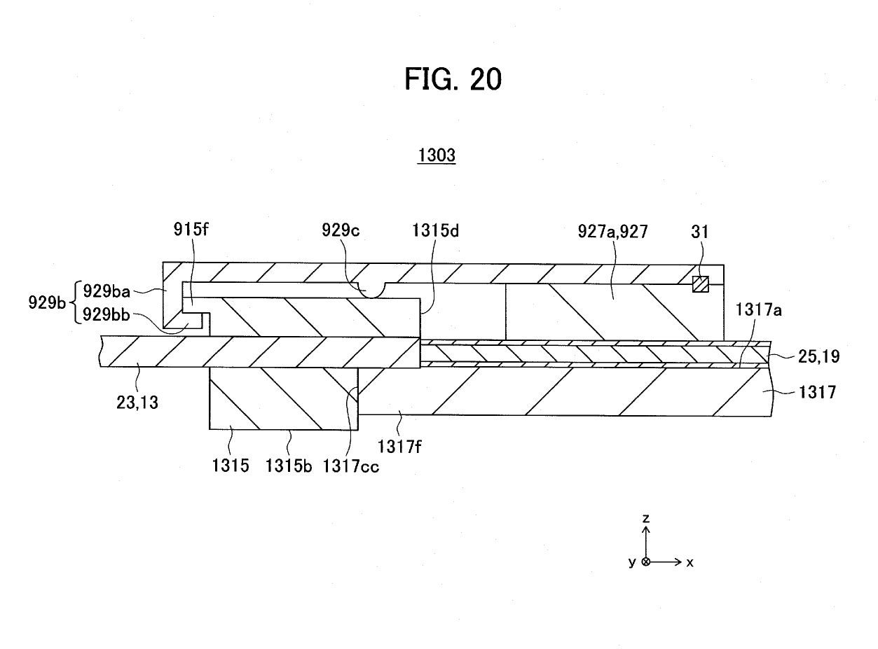

FIG. 20 is a cross-sectional view similar to FIG. 17 and shows an optical connector 1303 according to an 11th embodiment.

In the optical connector 1303, a board 1317 has a support part 1317f capable of supporting a plug 1315 from the side of the plug 1315 opposite to the abutting part 129c in the same way as the 10th embodiment.

In the 10th embodiment, the support part 1217f was formed by cutting out part of the board 1217 at the first major surface 1217a side at second connection part 1217cc side. However, in contrast, the support part 1317f is formed without cutting out part of the board 1317 at a first major surface 1317a side at a second connection part 1317cc side. Further, in the optical connector 1303, part of the plug 1315 is cut out at a bottom surface 1315b side at a first connection part 1315d side. Further, the first major surface 1317a abuts against the optical fibers 23 from the lower part side to support the optical fibers 23 and supports the plug 1315 through the optical fibers 23.

Accordingly, the same effect as that by the 10th embodiment is exerted, and influence of dimensional error of the plug and dimensional error of a cut-out part of the board exerted upon the connection between the optical fibers 23 and the optical waveguides 25 is suppressed.

### 12th Embodiment

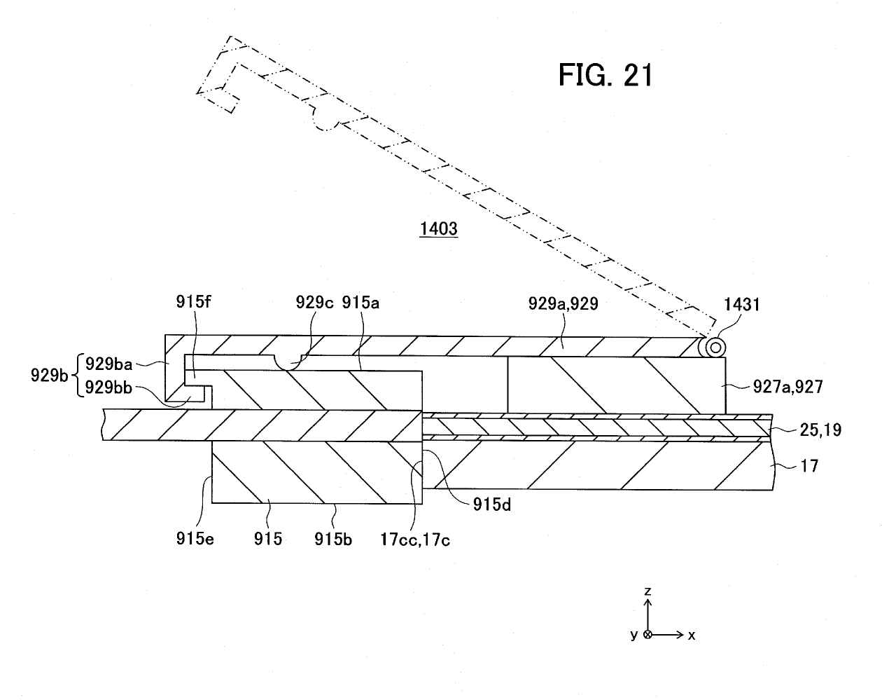

FIG. 21 is a cross-sectional view similar to FIG. 17 and shows an optical connector 1403 according to a 12th embodiment.

The optical connector 1403 differs from the optical connector 903 in the ninth embodiment only in a point that the lid member 929 is supported by a support 1431 so as to be rotatable around the y-axis with respect to the support member 927. According to the present embodiment as well, the same effect as that by the ninth embodiment is exerted.

In the present embodiment, by fitting the plug 915 in the holding portion 927b of the support member 927 in the state where the lid member 929 is moved upward, and moving the lid member 929 downward, connection can be carried out. Accordingly, for example, this is useful in a case where it is difficult to secure space for extracting and inserting the plug 915 in the x-direction or the like.

### 13th Embodiment

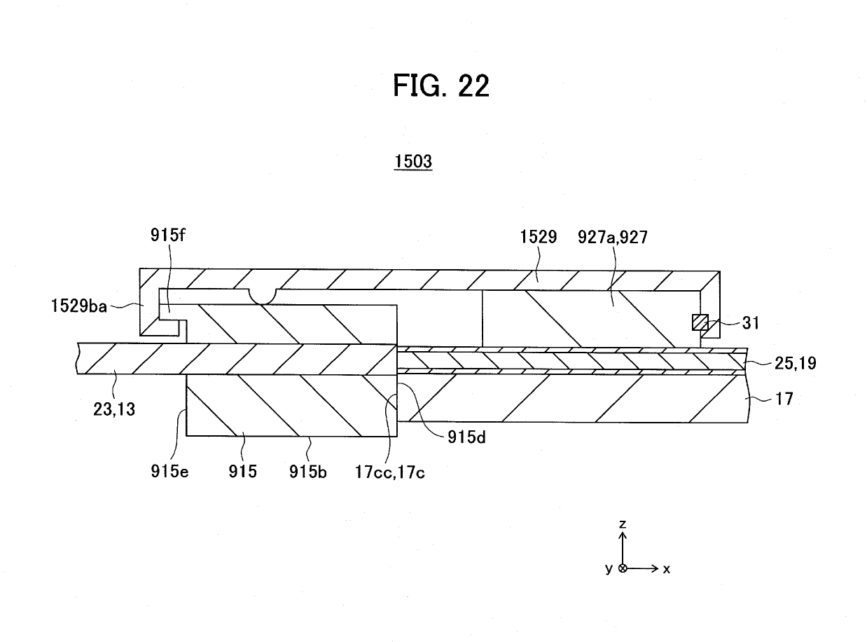

FIG. 22 is cross-sectional view similar to FIG. 17 and shows an optical connector 1503 according to a 13th embodiment.

The optical connector 1503 differs from the ninth embodiment only in the position of the support 31 for fastening a lid member 1529 to the support member 927. Specifically, the position of the support 31 in the z-direction is made equal to the abutting position of the first engagement part 1529ba with respect to the engaged part 915f.

According to the present embodiment, the plug 915 can be efficiently pressed and positioned in the x-direction, and generation of a moment which tries to rotate the lid member 1529 around the support 31 is suppressed.

### 14th Embodiment

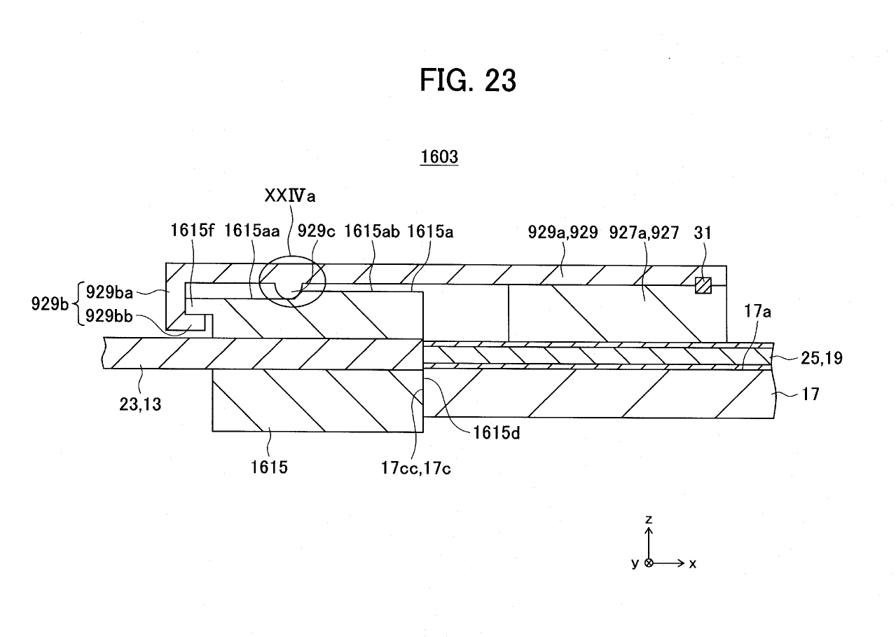

FIG. 23 is a cross-sectional view similar to FIG. 17 and shows an optical connector 1603 according to a 14th embodiment.

The optical connector 1603 differs from the ninth embodiment only in a shape of an upper surface 1615a of a plug 1615. Specifically, the upper surface 1615a has a first surface 1615aa on an engaged part 1615f side and a second surface 1615ab which becomes higher than the first surface 1615aa. Further, the abutting part 929c is positioned in a step formed by the first surface 1615aa and the second surface 1615ab.

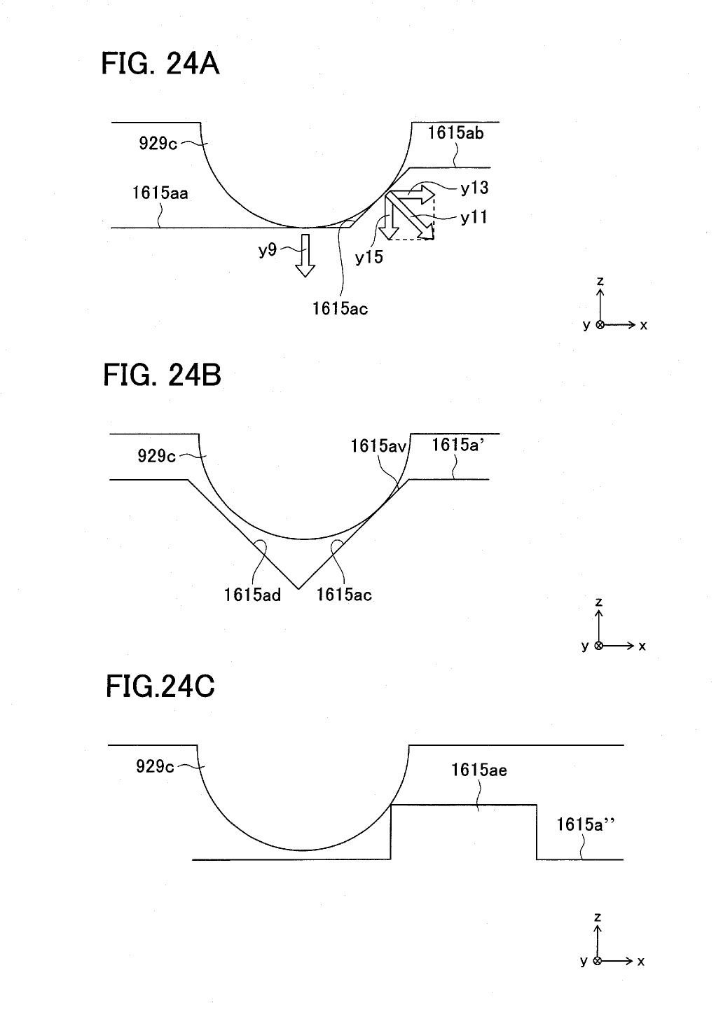

FIG. 24A is an enlarged view of a region XXIVa in FIG. 23.

An inclined surface 1615ac is formed in the step formed by the first surface 1615aa and the second surface 1615ab. The inclined surface 1615ac is inclined relative to the connection direction of a first connection part 1615d and second connection part 17cc (x-direction) so that the second connection part 17cc side (second surface 1615ab side) approaches the lid member 929 side. Further, the abutting part 929c abuts against the first surface 1615aa and abuts against the inclined surface 1615ac.

The action of the abutting part 929c upon the first surface 1615aa is the same as that in the ninth embodiment. That is, when the first engagement part 929ba engages with the engaged part 1615f, the abutting part 929c imparts a force to the negative side in the z-direction, which is indicated by an arrow y9, to the first surface 1615aa.

The action of the abutting part 929c upon the inclined surface 1615ac is as follows. When the first engagement part 929ba engages with the engaged part 1615f, in the same way as the first embodiment, the abutting part 929c tries to move to the negative side in the z-direction. On the other hand, the inclined surface 1615ac is limited in movement to the negative side in the z-direction by the second engagement part 929bb etc. and abuts against the abutting part 929c with an inclination relative to the z-direction. Accordingly, the abutting part 929c tries to push aside the inclined part 1615ac to the positive side in the x-direction while making the inclined 1615ac slide. That is, the abutting part 929c imparts a force indicated by an arrow y13 to the inclined surface 1615ac.

From another viewpoint, if considered while ignoring the frictional resistance of the inclined surface 1615ac, the abutting part 929c imparts a force indicated by an arrow y11 perpendicular to the inclined surface 1615ac to the inclined surface 1615ac. This force can be broken down to a force component to the positive side in the x-direction which is indicated by an arrow y13 and a force component to the negative side in the y-direction which is indicated by an arrow y15. The force component which is indicated by the arrow y13 contributes to the biasing of the plug 1615 to the positive side in the x-direction, while the force component which is indicated by the arrow y15 contributes to the biasing of the plug 1615 to the negative side in the z-direction together with the force which is indicated by the arrow y9.

According to the sixth embodiment, the force (force indicated by the arrow y13) pressing the first connection part 1615d against the second connection part 17cc can be obtained not only by the first engagement part 929ba, but also by the abutting part 929c, therefore connection of the first connection part 1615d and the second connection part 17cc is more reliably achieved. Further, this means that the abutting part 929c engages with respect to the inclined surface 1615ac in the direction from the first connection part 1615d side to the second connection part 17cc side, therefore inadvertent detachment of the plug 1615 from the receptacle 921 is suppressed.

Note that, in the present embodiment, force to the negative side in the z-direction is imparted to the plug 1615 by the abutting part 929c abutting against the first surface 1615aa, but force to the negative side in the z-direction may be imparted to the plug 1615 (inclined surface 1615ac) without the abutting part 929c abutting against the first surface 1615aa by making the inclination angle of the inclined surface 1615ac relative to the x-direction gentler and/or making the frictional coefficient between the inclined surface 1615ac and the abutting part 929c larger.

(Modifications of 14th Embodiment)

FIG. 24B is a cross-sectional view corresponding to FIG. 24A and shows a first modification of the 14th embodiment.

In this modification, the inclined surface 1615ac is formed by formation of a groove 1615av having a V-shaped cross-section in an upper surface 1615a′ of the plug. An action similar to that by the 14th embodiment explained above is also exerted upon the inclined surface 1615ac formed in this way. Note that, the abutting part 929c may abut against an inclined surface 1615ad on the side opposite to the inclined surface 1615ac with a relatively weak force by sliding against the inclined surface 1615ac or may not abut. Further, the groove 1615av may be formed in a shape that fits with the abutting part 929c. When the groove 1615av is formed in this way, at the time of insertion of the plug 1615 into the receptacle assembly 907, the groove 1615av of the plug 1615 and the abutting part 929c of the lid member 929 engage. For this reason, even when insertion/extraction of the plug 1615 is repeated, fluctuation of the force pressing the plug 1615 against the facing surface 17c of the board 17 can be suppressed.

FIG. 24C is a cross-sectional view corresponding to FIG. 24A and shows a second modification of the 14th embodiment.

In this modification, a projection portion 1615ae is formed on an upper surface 1615a″ of the plug. Further, a corner of the projection portion 1615ae abuts against the curved surface (inclined surface) of the abutting part 929c. Even with such a configuration, the same action as that by the 14th embodiment explained above is exerted.

Note that, as understood from this modification, the inclined surface does not have to be a flat surface. Further, the inclined surface may be provided at either of the plug 1615 side or abutting part 929c side or may be provided on the two sides. Generally speaking, it is sufficient that a part with which the abutting part 929c abuts in a direction which is inclined from the first connection part 1615d side to the second connection part 17cc side relative to the direction (z-direction) perpendicular to the connection direction be provided at the plug 1615.

### 15th Embodiment

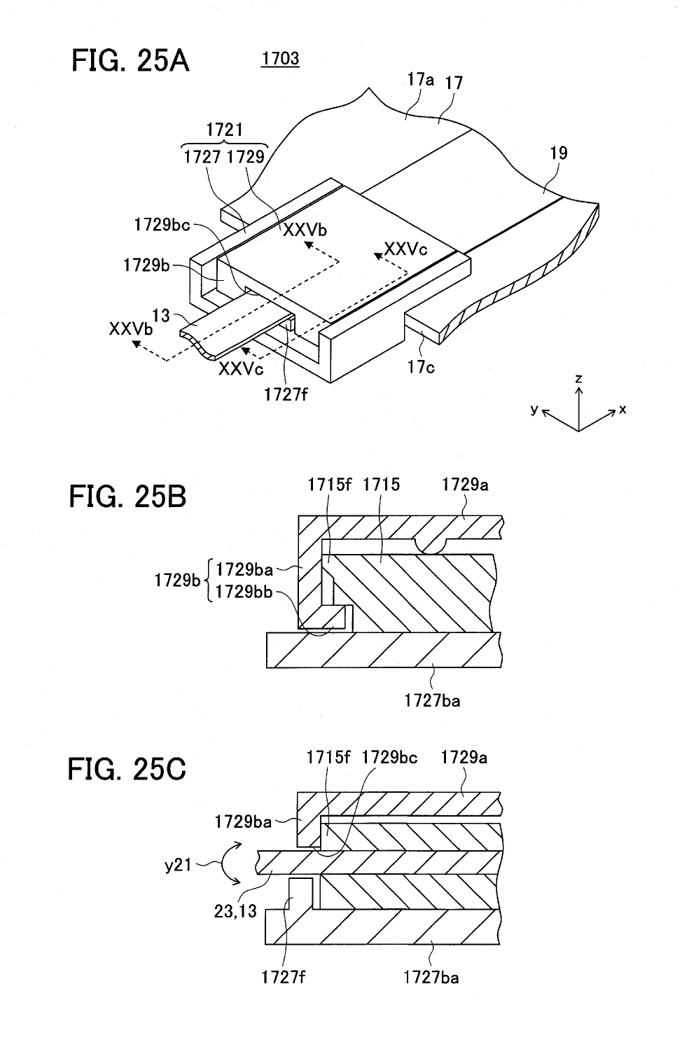

FIG. 25A is a perspective view similar to FIG. 17 and shows an optical connector 1703 according to a 15th embodiment. FIG. 25B is a cross-sectional view taken along a line XXVb-XXVb in FIG. 25A. FIG. 25C is a cross-sectional view taken along a line XXVc-XXVc in FIG. 25A.

Broadly speaking, the optical connector 1703 is comprised of the optical connector 903 in the ninth embodiment to which the function of limiting shaking of the optical cable 13 is added. Specifically, this is as follows.

In a lid member 1729 of a receptacle 1721, first engagement parts 1729ba of engagement function parts 1729b are formed as plate shapes which extend from an extension part 1729a to a bottom surface portion 1727ba of a support member 1727. Further, a cut-out portion 1729bc into which the optical cable 13 is inserted is formed. The first engagement parts 1729ba engage at their base sides with engaged parts 1715f which are formed on the upper surface side of a plug 1715 to the positive side in the x-direction.

Further, second engagement parts 1729bb are formed on the fronts of the portions of the first engagement parts 1729ba which are located on the two sides of the cut-out portion 1729bc and engage with the cut-out portion formed on the lower surface side of the plug 1715.

A support member 1727 has a limiting portion 1727f which projects from a bottom surface portion 1727ba and is positioned in the cut-out portion 1729bc. The front end of the limiting portion 1727f is positioned closer to the first engagement part 1729ba side than the abutting part (not shown) of the lid member 1729 and faces the edges of the first engagement parts 1729ba (the upper side edges of the cut-out portion 1729bc) while sandwiching the optical cable 13 therebetween.

Note that, in the same way as the 12th embodiment, the lid member 1729 is supported to be able to rotate around the rotation axis parallel to the y-direction, and the plug 1715 is accommodated in the support member 1727 in a state where the lid member 1729 is lifted up. After that, the lid member 1729 is lowered whereby it is fixed in the receptacle 1721.

In the above embodiment, even when the optical cable 13 shakes as indicated by an arrow y21, the shaking can be suppressed by the lid member 1729 and limiting portion 1727f. As a result, the influence of the shaking exerted upon the connection is reduced. Further, the lid member 1729 contributes to such suppression of shaking, therefore the structure is simplified. Further, the edges on the first engagement part 1729ba side contribute to the limitation of shaking more than the abutting part, therefore it is also expected that the force by the optical cable 13 which biases the edge parts to the positive side in the z-direction will be converted to force bending the extension part 1729a and pressing the abutting part against the plug 1715.

Further, the opening in the receptacle 1721 on the optical cable 13 side is closed by the first engagement parts 1729ba and limiting portion 1727f, therefore entry of foreign matter into the inside of the optical connector 1703 is suppressed.

Note that, the limiting portion which faces the lid member 1729 while sandwiching the optical cable 13 therebetween may be formed in the plug 1715 or may be formed in both of the support member 1727 and the plug 1715.

### 16th Embodiment

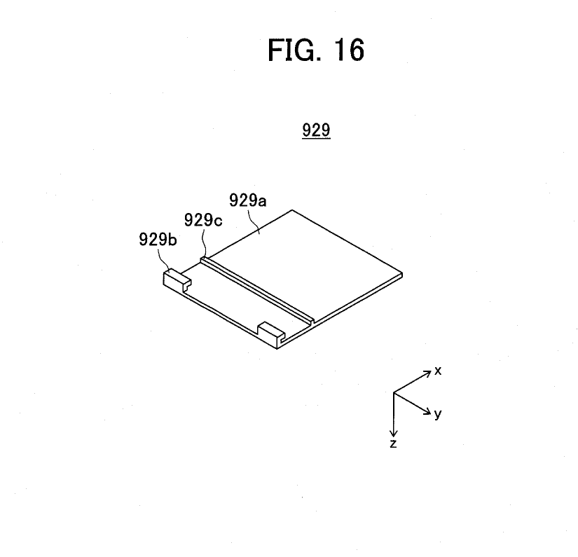

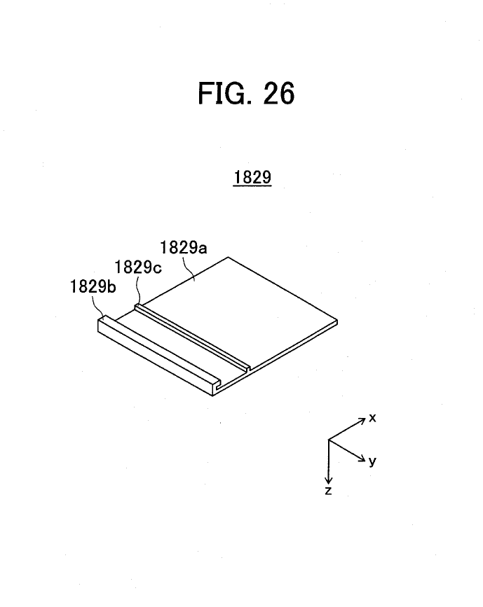

FIG. 26 is a perspective view similar to FIG. 16 and shows a lid member 1829 of an optical connector according to a 16th embodiment.

In the lid member 1829, an engagement function part 1829b extends over the width of an extension part 1829a in the same way as an abutting part 1829c. Note that, although not particularly shown, an engaged part of the plug which engages with the engagement function part 1829b extends in the width direction (y-direction) of the plug in the same way as the engagement function part 1829b. In this lid member 1829, compared with the ninth embodiment, shaking in the z-direction of the optical cable 13 can be suppressed.

Note that, in the above embodiments, the optical fibers 23 are examples of first optical transmission line, each of the plugs 15, 215, 315, 515, 715, 815, 915, 1315, 1615, and 1715 is example of the first holding member, the lower surfaces (15b etc.) of these plugs are examples of the lower surface of the first holding member, the optical waveguides 25 are examples of the second optical transmission line, the combinations of the board 17, 1217, or 1317 with the support member 27, 327, 627, 927, or 1727 are examples of the second holding member, the bottom surfaces (27baa etc.) of these support members are examples of the bottom surface of the second holding member, each of the lid members 29, 929, 1529, and 1729 is example of the connection member, each of the boards 17, 1217, and 1317 is example of the base, and each of the inclined surface 1615ac and projection portion 1615ae is example of the abutted part.

The present invention is not limited to the above embodiments and may be executed in various aspects.

The above embodiments may be suitably combined. For example, any of the first to eighth embodiments and any of the ninth to 16th embodiments may be combined. Further, for example, the support part of the 10th or 11th embodiment may be provided in the 12th to 16th embodiments, the support point of rotation in the 12th embodiment may be provided in the 13th, 14th, and 16th embodiments, the position of the support point in the 13th embodiment may be applied to the 14th to 16th embodiments, and the inclined surface in the 14th embodiment may be provided in the 15th and 16th embodiments.

The optical connector is not limited to one connecting an optical cable and an optical waveguide strip provided on a board and may be for example one connecting optical cables to each other. The optical transmission line is not limited to one configured by an optical fiber or optical waveguide. For example, the optical transmission line may be configured by including an optical fiber and a lens.

The first component member and the second component member are not limited to those fastened together by a binder and may be those fastened together by for example screws.

The second holding member is not limited to one configured by a base which holds the second optical transmission line and a support member which holds the connection part. For example, the second holding member may be formed by a single integrally formed member. Further, in the case where the second holding member is configured by a base and a support member, the base is not limited to a board and may be configured by a member which has a suitable shape such as a cylinder shape.

The extension part of the connection member (lid member) does not have to extend parallel to the abutting direction (connection direction) of the first connection part and the second connection part and may extend obliquely relative to the abutting direction.

The first engagement part of the connection member does not have to project to a direction perpendicular to the connection direction and may project to a direction obliquely intersecting the connection direction. Further, it does not have to project at the front end of the connection member and may project from a suitable position of the connection member.

The second engagement part of the connection member does not have to project from the front end of the first engagement part. It may project from the extension part at a suitable position closer to the first engagement part side than the abutting part.

It is not necessary to configure the abutting part of the connection member by a projection portion. For example, in the extension part 929a in the ninth embodiment, a portion of the flat surface at the side of the plug 915 may abut against the plug 915 as the abutting part. Note that, in this case, as exemplified in FIG. 24C, a projection portion abutting against the extension part 929a may be provided at the plug 915.

The receptacle configuring the second holding member does not have to cover the entire circumference of the first holding member (lower surface, upper surface, and two side surfaces). For example, in the first embodiment etc., the lid member 29 need not be provided. A wire-shaped member may be provided in place of the side surface portion 27bb and lid member 29. Further, in the first embodiment, the support member 27 had a shape where the upper surface was opened, but may be shaped so that the side surface is opened.

In the optical connector according to the first aspect (the optical connector having a space configured between the lower surface of the first holding member and the bottom surface of the second holding member), the method of engagement of the first holding member and the second holding member (connection maintaining method) may be suitably changed. For example, in the first embodiment etc., an engagement part for preventing inadvertent detachment of the plug 15 may be provided in the side surface portion 27bb in place of the engagement part 29b of the lid member 29, rise up of the plug 15 may be suppressed by the lid member 29 without providing the guide projection portion 27bc, or connection may be maintained by a method other than engagement, for example, a magnet.

The space is not limited to a space which is formed by formation of a concave portion in the lower surface of the first holding member and/or bottom surface of the second holding member. For example, a space may be formed by a plurality of projection portions which are scattered around or aligned in the lower surface and/or inner side surface. Further, the space may be superposed on at least a portion of the plurality of first optical transmission lines and does not have to be superposed on them as a whole.

The shape of the concave portion (space) is not limited to a box shape. For example, the concave portion may be one where the bottom surface is curved in a spherical surface shape. In this case, in the same way as an arch, the strength of the plug and/or receptacle is improved. Further, the concave portion may be formed so that the width changes when viewed on a plane, for example, may be formed in a trapezoidal or triangular shape when viewed on a plane. Further, it is not necessary to form the concave portion in the groove shape which extends over the entire first holding member. It may be provided in for example only the front of the first holding member (connection side).

As in the fourth and fifth embodiments (FIG. 10, FIG. 11), in the case where a concave portion is formed in both of the first holding member and the second holding member and the space is configured by the concave portions of the two, the concave portions of the two do not have to differ in width etc. from each other and may have the same width etc. as each other.

Further, in the case where the height of the space changes as in the fourth and fifth embodiments, the space is not limited to one configured by the concave portions of the two of the first holding member and second holding member. That is, the concave portion may be formed in only either of the first holding member or second holding member, and the height of the space may change by a change in the depth of that one concave portion.

Further, the change in the height of the space need not only be a single step change and may also be a two or more step change. For example, in the fourth embodiment (FIG. 10), by formation of the concave portions 515h shown in FIG. 11 in the bottom surface of the concave portion 15h, two step change may be obtained in the space. Further, the change in the height of the space may be made a continuous one by a curved surface or inclined surface.

The positioning portions (627f, 715m, 815m) exemplified in the sixth to eighth embodiments (FIG. 12 to FIG. 14) do not have to have the same shapes and sizes as those of the concave portion when viewed on a plane. For example, they may be rib shaped so as to abut against the inner wall surface of the concave portion. The concave portion does not have to be groove shaped extending in the connection direction. The positioning portions are not limited to only ones for performing positioning in the width direction either. For example, they may be ones which abut against the rear inner wall surface of the concave portion.

The shapes of the component members (first holding members and plugs) which are integrally formed and into which the optical fibers are inserted and the support members (second holding members, receptacles) combined with the former component members as exemplified in the seventh and eighth embodiments (FIG. 13, FIG. 14) may be suitable shapes. For example, they may be made the same as the shapes of the plugs and receptacles in the first to sixth embodiments.

In the optical transmission module, it is not necessary to provide the light receiving element and light emitting element on both of the first optical transmission line side and the second optical transmission line side. That is, in the optical transmission module, either of the light receiving element or light emitting element may be provided on the first optical transmission line side, and the other of the light receiving element and light emitting element may be provided on the second optical transmission line side.

Note that, in the explanation of the problems, as inconveniences occurring in the prior art, the necessity of formation of parts into which the guide pins are inserted and the entry of noise etc. into the gaps between the end faces of the holding members were illustrated, but it is not necessarily required to solve these problems in the present invention. The invention of the present application differs in configuration from the prior art by the provision of the bottom surface etc. or provision of the abutting part etc. As a result, some sort of advantageous effects compared with the prior art are exerted.

### REFERENCE SIGNS LIST

3 . . . optical connector, 15 . . . plug (first holding member), 15b . . . lower surface, 17 . . . board (second holding member), 27 . . . support member (second holding member), 23 . . . optical fiber (first optical transmission line), 25 . . . optical waveguide (second optical transmission line), 27baa . . . bottom surface, and 2 . . . space.

1. An optical connector, comprising:
a first holding member which
holds a plurality of first optical transmission lines arranged in parallel in a left-right direction and
has a lower surface located along a direction the plurality of first optical transmission lines arranged; and
a second holding member which
holds a plurality of second optical transmission lines arranged in parallel in a left-right direction and
has, at a part which projects out toward a side of the first holding member, a bottom surface which faces the lower surface and positions the lower surface, when butting joint end faces of the plurality of first optical transmission lines and end faces of the plurality of second optical transmission lines, respectively,
wherein a space which is located between the lower surface and the bottom surface is located below the plurality of first optical transmission lines.

2. The optical connector according to claim 1, wherein the space is formed with a width of a width of the plurality of first optical transmission lines as a whole or more.

3. The optical connector according to claim 1, wherein
the first holding member has
a first component member which has the lower surface and a first surface on a side opposite to the lower surface,
a second component member which has a second surface which sandwiches the plurality of first optical transmission lines with the first surface, and
a binder which is interposed between the first surface and the second surface over an adhesion region which has a broader width than the width of the plurality of first optical transmission lines as a whole, and
the space is formed with a width of a width of the adhesion region or more.

4. The optical connector according to claim 1, wherein the lower surface has a concave portion configuring the space.

5. The optical connector according to claim 1, wherein
either of the lower surface and the bottom surface has a first concave portion which configures the space and has a broader width than the width of the plurality of first optical transmission lines as a whole, and
the lower surface has a second concave portion which configures the space together with the first concave portion and has a width narrower than a width of the first concave portion and not less than the width of the plurality of first optical transmission lines as a whole.

6. The optical connector according to claim 1, wherein the lower surface has a plurality of concave portions which are located below the plurality of first optical transmission lines and configure the space.

7. The optical connector according to claim 1, wherein
either of the lower surface and bottom surface has a concave portion which configures the space, and
the other of the lower surface and the bottom surface has a positioning portion which abuts against an inner wall surface of the concave portion.

8. The optical connector according to claim 1, comprising
a connection member which
is supported by the second holding member and
engages with the first holding member when butting joint an end faces of first optical transmission lines and an end faces of second optical transmission lines, wherein
the connection member has
an extension part which
extends from a side of the second holding member to the side of the first holding member and
is supported by the second holding member so that a part at the second holding member side is kept from moving in the connection direction,
a first engagement part which
projects out from a part of the extension part on the side of the first holding member in a direction which intersects with the connection direction and
can engage with a certain engaged part of the first holding member in a direction from the side of the first holding member to the side of the second holding member, and
an abutting part which
is located at the side of the second holding member other than the first engagement part of the extension part and
can abut against the first holding member toward the side to which the first engagement part projects, and
before engagement of the first engagement part, a distance in the connection direction from the end faces of the second optical transmission lines to the first engagement part is shorter than the distance in the connection direction from the end faces of the first optical transmission lines to the engaged part.

9. The optical connector according to claim 8, wherein
the connection member further has a second engagement part which
is supported by the extension part on the first engagement part side other than the abutting part and
can engages with the first holding member to a side opposite to the side to which the first engagement part projects.

10. The optical connector according to claim 8, wherein the second holding member has
a base having a surface against which the first holding member abuts and
a support member which is connected to the base and supports the connection member.

11. The optical connector according to claim 10, wherein
either of the base and support member has a projection portion which projects to the side to which the first engagement part projects or the side opposite to which the first engagement part projects, and
the other of the base and the support member has a hole in which the projection portion is inserted so that movement is suppressed in a direction perpendicular to the connection direction and perpendicular to a projection direction of the projection portions.

12. The optical connector according to claim 11, wherein an inside diameter of the hole in the connection direction is larger than an outside diameter of the projection portion in the connection direction.

13. The optical connector according to claim 10, wherein the base has a support portion which is capable of supporting the first holding member from the side opposite to the abutting part.

14. The optical connector according to claim 13, wherein in a state where the first engagement part is engaged, the abutting part and the support part are superposed on each other on a perspective plane viewed in the abutting direction of the abutting part.

15. The optical connector according to claim 8, wherein
in the first holding member, the end faces of the plurality of first optical transmission lines are arranged in the width direction perpendicular to the connection direction and perpendicular to the abutting direction of the abutting part and are exposed,
in the second holding member, the end faces of the plurality of second optical transmission lines are arranged in the width direction and are exposed, and
the abutting part extends in the width direction.

16. The optical connector according to claim 8, wherein the first holding member has an abutted part against which the abutting part abuts in a direction inclined from the side of the first holding member to the side of the second holding member relative to the direction perpendicular to the connection direction.

17. The optical connector according to claim 8, wherein
the first optical transmission lines extend from the first holding member at the side opposite to the side connected to the second optical transmission lines and
at least one of the first holding member or second holding member has a limiting part which
is located at the first engagement part side other than the abutting part of the connection member and
faces the end part of the first engagement part while sandwiching the extension portions of the first optical transmission lines therebetween.

18. An optical transmission module, comprising
an optical connector according to claim 1,
second optical transmission lines, and
at least one of light emitting elements for inputting light to the second optical transmission lines and light receiving elements for receiving light output from the second optical transmission lines.

19. A method of production of an optical connector including a holding member which holds a plurality of optical transmission lines in a state where they are arranged in parallel in a left-right direction, comprising:
a step of inserting the plurality of optical transmission lines arranged in parallel in the left-right direction and a binder between a first component member which becomes a lower side component member and a second component member which becomes an upper side component member which configure the holding member; and
a step of curing the binder by heating the first component member and the second component member while pressing against them in an insertion direction of the plurality of optical transmission lines, wherein
a concave portion is formed in the surface of the first component member on the side opposite to the second component member, and a jig for heating and pressing is abutted against the concave portion in the step of curing.
